(19) United States
(12) Patent Application Publication
(10) Pub. No.: US 2013/0036369 A1
(43) Pub. Date: Feb. 7, 2013

(54) SYSTEMS AND METHODS FOR MANAGING EVENT-RELATED INFORMATION

(71) Applicants: Alexander John Mitchell, Newport Beach, CA (US); John Correa, Newport Beach, CA (US); Robert Rodrigues, Newport Beach, CA (US)

(72) Inventors: Alexander John Mitchell, Newport Beach, CA (US); John Correa, Newport Beach, CA (US); Robert Rodrigues, Newport Beach, CA (US)

(73) Assignee: SquaredOut, Inc., Newport Beach, CA (US)

(21) Appl. No.: 13/196,229

(22) Filed: Aug. 2, 2011

(51) Int. Cl. G06F 3/00; G06F 15/16

(52) U.S. Cl. 715/753

(57) ABSTRACT

An embodiment of the invention is a method of integrating public and private calendars on a user-specific basis, such that a user is able to view multiple shared calendars created by different users. A system maintains event data relating to a future event, and receives a request to add that event to one of the user's calendars. The system creates a link between that event and the calendar, configuring the link so that updates to the event are automatically reflected on the calendar. It further enables the user to modify attributes associated with the event.

### BACKGROUND OF THE INVENTION

Modern communication systems, such as the internet, provide individuals with an abundance of information. In particular, recent developments in social media networking enable individuals to easily connect with other individuals and organizations and quickly receive news and updates from them.

However, this abundance of information has let to an information overload. Substantial amounts of data are provided to users on a daily basis and often the amount of information transmitted can be more than a user can easily read or manage. Users are forced to manually find and organize information of interest so that they may act upon it in the future.

In particular, with regard to calendar and event information, information is given to users in a multiplicity of formats, such as newsletters, blogs, microblogs, websites, and the like. The user is forced to translate this unorganized data into personal calendars or notes in order to have records of upcoming events of interest to the user.

### SUMMARY OF THE INVENTION

In one embodiment of the invention, there is provided a system and method to organize calendar and event information from a multiplicity of sources and to enable two-way communication between the recipient of information and the providers of event and calendar information, and additionally a unified interface for managing public and private calendar information.

An embodiment of the invention is a method of integrating public and private calendars on a user-specific basis, such that a user is able to view multiple shared calendars created by different users. A system maintains event data relating to a future event, and receives a request to add that event to one of the user's calendars. The system creates a link between that event and the calendar, configuring the link so that updates to the event are automatically reflected on the calendar. It further enables the user to modify attributes associated with the event.

In an embodiment, the system receives a request to add another event to another calendar. The system determines that the two events correspond to each other. Accordingly, the system constructs a user interface displaying the two events in a consolidated form. The system may graphically indicate the association of the consolidated form with either of the two calendars, in response to a user input action such as a mouse click or hover.

In an embodiment, the system receives a request to modify the date of an event. It modifies the date, and sends notification messages regarding the modification of the date. It further displays the modified event on a graphical user interface.

In various embodiments, additional features may be provided such as access control, searching, and displays of events on third-party web pages. The disclosed embodiments thus advantageously provide numerous features useful to the management of calendars and events. In particular, embodiments of the invention provide for integration of public and private calendars managed by multiple users of the system. These and other features are explained in detail in the following disclosure.

### BRIEF DESCRIPTION OF THE DRAWINGS

FIG. 1 is a block diagram illustrating an embodiment of a calendar computing system.

FIG. 2 is a sample user interface used by an embodiment showing a user's calendar.

FIG. 3 is a sample user interface of an embodiment showing a pop-up window over the main calendar window.

FIG. 4 is an enlarged view of the pop-up window for entering user settings used in an embodiment.

FIG. 5 is a schematic diagram of data elements and their relationships as employed by an embodiment.

FIG. 6 is a flowchart depicting a process of creating a new calendar as used by an embodiment.

FIG. 7 is a sample user interface depicting a pop-up window for adding a new private calendar as used in an embodiment.

FIGS. 8-10 are screen shots of the user interface for adding a new public calendar as used in an embodiment.

FIG. 11 is a flowchart of a process of creating a new event as used in an embodiment.

FIG. 12 is a sample user interface for adding a new event to a calendar as used in an embodiment.

FIG. 13 is a sample user interface for updating an event on a calendar as used in an embodiment.

FIG. 14 is a sample user interface for inviting friends to a private calendar as used in an embodiment.

FIG. 15 is a sample user interface for modifying user privileges for members of a calendar as used in an embodiment.

FIG. 16 is a sample user interface for managing the display of multiple calendars as used in an embodiment.

FIG. 17 is a sample user interface for highlighting certain selected events as used in an embodiment.

FIG. 18 is a sample user interface for organizing calendars as used in an embodiment.

FIG. 19 is a sample user interface for adjusting color settings for calendars as used in an embodiment.

FIG. 20 is a sample user interface for selecting certain calendars as used in an embodiment.

FIG. 21 is a sample user interface displaying details of an event as used in an embodiment.

FIG. 22 is a sample user interface displaying details of a public event as used in an embodiment.

FIG. 23 is a flowchart of a process of searching for events as used in an embodiment.

FIG. 24 is a sample user interface for searching calendars as used in an embodiment.

FIG. 25 is a sample user interface displaying detailed search results as used in an embodiment.

FIG. 26 is a sample user interface displaying a preview of a calendar as used in an embodiment.

FIG. 27 is a sample user interface for searching for events as used in an embodiment.

FIG. 28 is a sample user interface displaying further details of an event identified in the search as used in an embodiment.

FIG. 29 is a sample user interface for linking an event identified in the search results to a user's calendars as used in an embodiment.

FIG. 30 is a sample user interface presenting options for searching events and/or calendars as used in an embodiment.

FIG. 31 is a flowchart of a process of linking an event to a calendar as used in an embodiment.

FIG. 32 is a flowchart of a process of associating a calendar with a user account as used in an embodiment.

FIG. 33 is a further process of associating a user with a calendar as used in an embodiment.

FIGS. 34 and 35 are flowcharts of a process of constructing a user interface of a calendar as used in an embodiment.

FIG. 36 is a flowchart of a process of displaying calendar and/or event information on third-party websites as used in an embodiment.

FIG. 37 is a flowchart of a process of linking an event shown on a third-party website with a user account as used in an embodiment.

FIG. 38 shows a user interface displaying statistics about a calendar, as used in an embodiment.

FIG. 39 shows a user interface for linking one or more events to a calendar, as used in an embodiment.

FIG. 40 is a sample block diagram of a computing system used in an embodiment.

### DETAILED DESCRIPTION OF THE PREFERRED EMBODIMENT

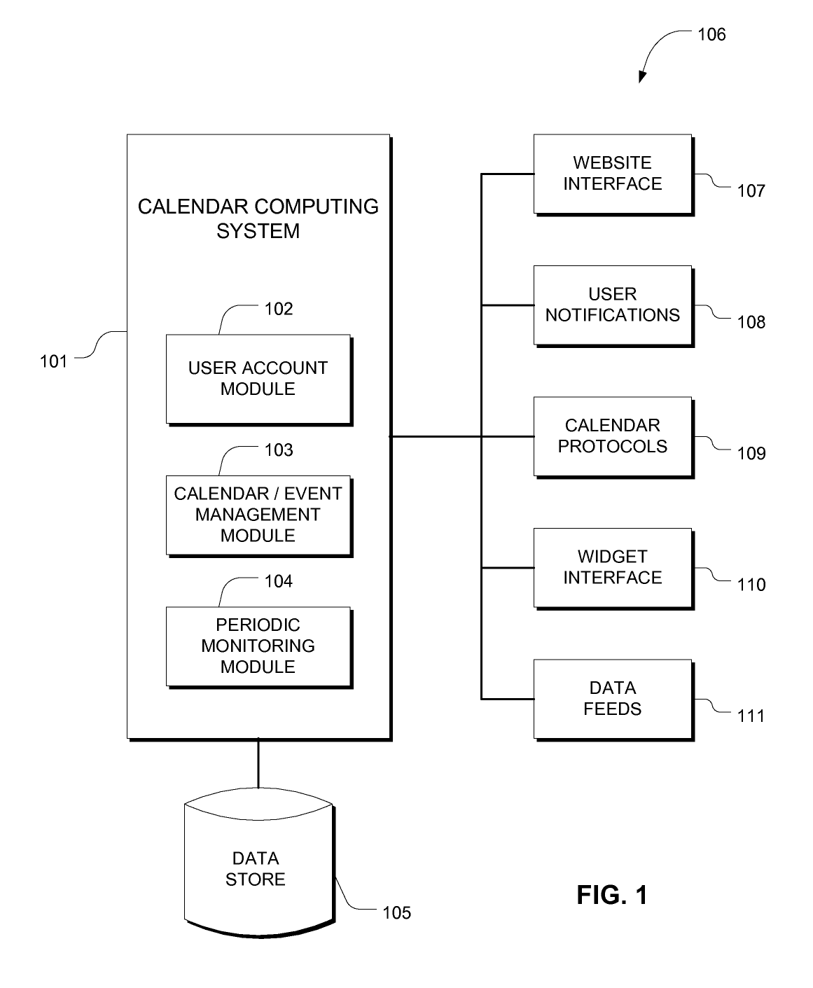

Presented herein are systems and methods of automatically organizing and managing calendar and event information. FIG. 1 is a block diagram of various components of an embodiment. A calendar computing system 101 includes computing hardware and a number of software modules such as a user account module 102, a calendar and event module 103, and a periodic monitoring module 104. The user account module may provide features for managing multiple user accounts. For example, user accounts may be based on user name and password logins. The user account module additionally retains profile information relating to users, such as the user's name, address, telephone number and other relation information. In various embodiments, user accounts may be stored in a data store 105 which may be, for example, a relational database.

The calendar and event module 103 provides functions for organizing calendar and event information associated with individual user accounts. This module may provide features such as calendar creation, calendar modification, linking events and calendars, creating new events, searching for events, and so on. The periodic monitoring module 104 handles tasks performed on a routine or periodic basis in an embodiment. For example, certain events may require alerts prior to the occurrence of the event, and the periodic monitoring module would periodically monitor such events and trigger notifications or messages that are sent to the users. The data store 105 may comprise one or more computer-readable media, such as hard drives or network storage. It may be internal to the calendar computing system or connected via a network or other means and external to the calendar computing system. The data store may be formatted in any number of ways, such as a relational data store, a flat-file data store, a distributed database, or the like.

The calendar computing system may present, in various embodiments, any number of public interfaces 106 through which individuals may interact with the system. These interfaces may be accessed by a number of means, such as by network communications, including but not limited to the internet, by cell phone or other telephone networks, by dial-up connections, or by other communication means. Some public interfaces that may be used in embodiments include a website interface 107, a user notifications interface 108, a calendar protocol interface 109, a widget interface 110, and a data feed interface 111.

The website interface 107 presents users with a graphical display of calendar and event-related information and is intended to be viewed in a web browser on a client's computer over the internet. The website interface may, in some embodiments, take on various forms, depending on the type of device from which the user is accessing the calendar computing system 101. For example, a mobile phone accessing the website interface 107 may see a more minimal user interface to conform to the smaller form factor of the mobile device, while a user of a desktop computer would see a more comprehensive user interface.

The user notifications interface 108 provides for pushing information toward users from the calendar computing system. Information may be sent as notifications to users by numerous means known to those of skill in the art, such as email notifications, text message notifications, telephone calls, physical mail, and the like.

The calendar protocols interface provides an alternate interface for users to retrieve calendar data from the calendar computing system 101. In an embodiment, the calendar protocols conform to a standard protocol, such as the ICS protocol. In further embodiments, the calendar protocols may be specifically tailored to the features of the calendar computing system.

The widget interface 110 allows for users to retrieve information from the calendar computing system 101 via a third-party website. The third-party website may be configured to include specialized code that causes the web browser of the user to request information from the calendar computing system and further provides for interactions on the third-party website between the user and the calendar computing system.

The data feeds 111 provide a further alternative interface for users to access information on the calendar computing system. The data feeds may be in standard format, such as RSS or Atom feeds. Data feed information may also be sent by email or any other communication means, as described previously.

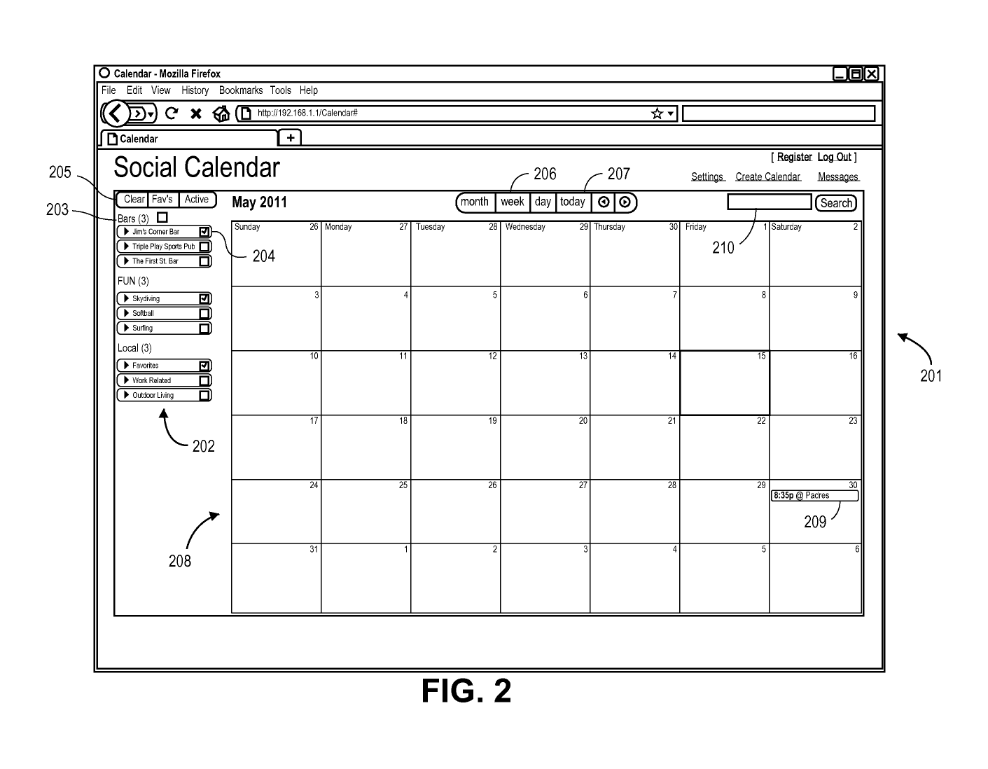

FIG. 2 illustrates a sample user interface 201 as presented by an embodiment of the system. The user interface may be presented via a web browser or it may be shown through a standalone application specially designed to interact with the calendar computing system. The user interface 201 includes a listing of calendars 202. The listing of calendars may be organized into groups 203 to better enable the user to identify particular calendars.

The individual calendars listed 204 may include a calendar name and a checkbox or other user interface element. The checkbox enables the user to toggle the display of events on the calendar, thus allowing the user to view events associated with only one or more particular calendars, at the user's choosing.

Additionally, the calendar interface 201 may include a search box 210 where a user may enter one or more search parameters for finding events and/or calendars. In an embodiment, interface element 210 accepts search keywords and may further accept other information such as location information to be used as parameters to the search. In an embodiment, the system may provide an advanced search option to enable the user to provide further details, queries, or parameters for searching.

A series of buttons 205 further assist the user in selecting certain calendars in the listing of calendars 202 for display. For example, the “clear” button allows the user to automatically deselect all of the calendars in listing 202. The “active” button enables the user to toggle between displaying only the active calendars and displaying all of the calendars. The “favorites” button enables the user to change the selection of calendars to a predefined list of favorite calendars. In an embodiment, multiple favorite lists may be included, and additional buttons in the set of buttons 205 may be included to allow the user to select among these various preselected lists.

In an embodiment, the user is able to select various formats for displaying events on the calendar using buttons 206. For example, selecting the “month” button causes the user interface to display an entire month of events. The “week” button displays only a week of events, and the “day” button displays only events for a particular day. The user may switch between various months, weeks or days using additional controls 207, which may, for example, enable the user to jump to the current day, to a previous day, to the next day, or to a day specified by the user.

In an embodiment, events on the calendar are displayed in region 208. The region is formatted to look like a calendar, presenting individual days and events on each day, such as event 209. In an embodiment, the events are organized based on the time associated with the events. In an embodiment, the events are placed on the calendar, both based on their time and their dates, thus enabling a user to visualize the schedule for a given day, week or month. In an embodiment, the events included in region 208 are those events within the relevant time frame that are associated with the calendars selected in listing 202. In another embodiment, all events within the relevant time frame and associated with calendars of the user's account are displayed in region 208, and the events associated with the calendars selected in listing 202 may optionally be highlighted or otherwise graphically identified.

In an embodiment, individual calendars 204 are associated with particular colors, either selected by the user or automatically assigned. The displays of the calendars 204 in the listing of calendars 202 are shown in the colors associated with each calendar, and events associated with a particular calendar, such as event 209, in calendar region 208, are colored to correspond with the associated calendar. So, for example, if event 209 is associated with a calendar that is colored green, the display of event 209 would also be colored green. In the case that event 209 is associated with multiple calendars, the system may choose which color to use for displaying the events based on any number of factors, such as a calendar priority, the order of selecting the calendars, or whether a calendar is currently being highlighted, or not.

In an embodiment, the user is able to manipulate events on the calendar by interacting with the calendar. For example, the user may be able to drag event 209 to a different day or time and thereby update the dates and/or time associated with event 209. In an embodiment, if the user is not permitted to modify an event, the user interface will prevent the user from dragging and dropping the events, either by not moving the display 209 of the events or by causing the display to return to its initial position after being dragged. In an embodiment, the user may organize calendars 204 into various groups 203 by dragging and dropping the calendars into particular groups.

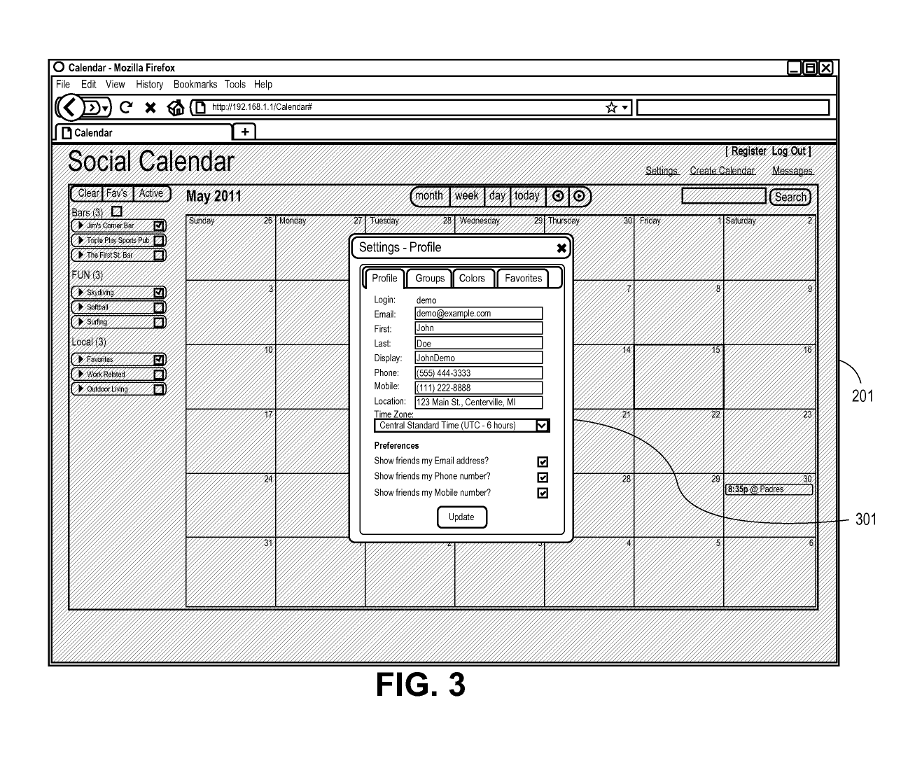

FIG. 3 shows an embodiment of a user interface with a pop-up window 301 over the calendar interface 201. In an embodiment, the calendar interface 201 is always shown in the background of user interfaces, thus providing the advantage of always showing the same calendar desktop to the user at all times. In an embodiment, the pop-up window 301 is shown within the web browser or application window 201. In an alternate embodiment, the pop-up window 301 may be shown in a separate window from the calendar interface 201. Additionally, in other embodiments, the information on pop-up window 301 may be shown on a separate web page or tab in a web browser. In an embodiment, interface 201 may optionally be shaded or obscured to indicate that there is an active pop-up window above it.

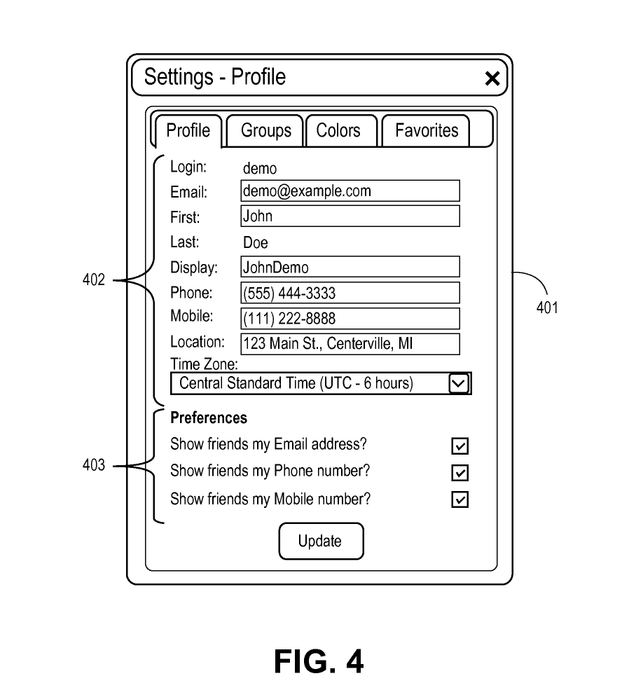

A user interface for providing user account settings, as used in an embodiment, is shown in FIG. 4. Window 401 includes one or more interface elements allowing users to provide personal information 402, such as a login name, email address, name, user display name, telephone number, address, time zone, and other information. The user may also indicate preferences for displaying information to other users on the system through interface elements 403. For example, a user may be able to decide whether to display the user's email address, phone number and/or mobile number to other users or to the public.

In an embodiment, all of the user profile information, such as that shown in window 401, may be received on a single window. In an embodiment, the information may be received through multiple windows or through multiple interfaces. Additionally, further information about a user or further privacy settings may be received. In other embodiments, not all of the information requested in interface elements 402 and/or 403 is required.

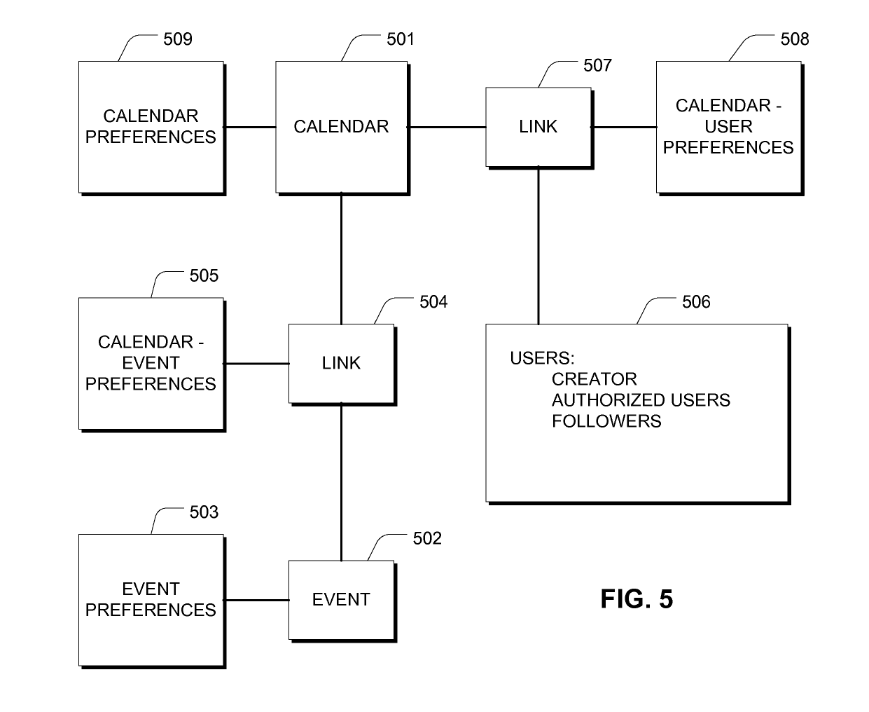

FIG. 5 shows a schematic diagram of data structures and elements as used in an embodiment. These data elements may be stored, for example, as objects in an object database or as records in tables of a relational database, or by other data storage means known to those of skill in the art. A data record for a calendar 501 is associated with calendar preferences 509. The calendar preferences may include data relating to the display of the calendar, information about the owner of the calendar, location-related information, and the like. Data associated with individual events 502 may also be stored in association with event preferences 503. The event preferences may similarly include information such as the time and date of the event, the location of the event, users associated with the events, and the like. In an embodiment, the calendar preferences data 509 is stored in the same record as the calendar record 501, and the event preferences 503 may be stored in the same record as the event 502. In an embodiment, the preferences data is stored in a separate record. Events and calendars may be associated with each other via a calendar event link 504. In an embodiment, the link comprises a data structure with an identifier of a calendar and an identifier of an event. The link may further be associated with calendar-event preferences 505.

The link 504 thus enables a many-to-many relationship between calendar data 501 and event data 502. Thus, multiple calendars may be associated with a single event, and multiple events may be associated with a single calendar. Indeed, an advantage of including link 504 is that a user account may be associated with a single event via multiple calendars of that account. Because the same event object is linked to multiple calendars for that user, the display of the event may be consolidated so that only one event is displayed rather than having the event displayed multiple times for each calendar. Furthermore, updates to the event object may thus be propagated across all linked calendars.

The calendar-event preferences 505 may include information about the display of a particular event, notes about an event, or further details about an event. In an embodiment, the calendar-event preferences 505 are used to override event preferences 503. For example, if an event is associated with a particular color, but the user wishes to change the color of the event as it is displaced on user interfaces, the system may only update the calendar-event preferences associated with that event and the appropriate calendar of the user. Thus, the display of the event will not be affected for other users who have a link to that same event. Users 506 may be associated with calendars 501 via a calendar user link 507.

A number of types of users may be associated with a calendar, in various embodiments. A calendar may be associated with a creator. A calendar may also associated with a set of authorized users who are given permissions to read, write and/or modify various aspects of a calendar. In an embodiment, a calendar is associated with one or more followers who have indicated an interest in a calendar. Followers may be users who have indicated an interest in following events on a publicly accessible calendar or other calendar.

Just as link 504 enables a many-to-many relationship between calendars 501 and events 502, link 507 enables many-to-many associations between calendars 501 and users 506, such that multiple users may be associated with a particular calendar and multiple calendars may be associated with a particular user. Additionally, the calendar user link may include calendar-user preferences 508. Similar to the calendar-event preferences 505, the calendar-user preferences may enable users to override certain default preferences of the calendar 509. This may include, for example, the color used to display the calendar or the name of the calendar.

In an embodiment, events and calendars may be associated without the use of a link 504. In an embodiment, calendars 501 and users 506 may be associated without the need for a link 507. This may be the case, for example, in the association between the creator of the calendar and the calendar itself, or the association between an event and the originating calendar for that event.

By employing links 504 and 507 to associate calendars, users, and events, the system may be able to automatically update changes to calendars and events. For example, if the time and date associated with an event 502 are modified, then all calendars 501 linked to that event 502 may have access to the modified event. In an embodiment, notifications may also be automatically generated and sent to appropriate users upon an update to an event. The system may determine a set of calendars linked to the modified event, and determine a set of relevant users linked to the set of calendars (such as all linked users, only users linked as followers, and so on). The system may then send appropriate notifications to that set of users. In an embodiment, the user modifying the event has the option of whether to send the notifications to interested users, and may specify criteria for which users are to receive those notifications.

Similarly, modifications to calendars may trigger notifications to interested users such as followers of the calendar or calendar members. For example, a change of the location associated with a calendar may cause a notification to followers of the calendar to be sent, so that the followers may be updated as to the new notification. As another example, notifications may be sent when a new calendar member is added, so that other members of the same calendar may be informed of the new member. Also as another example, notifications may be sent to followers or members when a new event is added to a calendar. As with notifications for event updates, notifications for calendar updates may be sent at the option of the modifying user, in an embodiment.

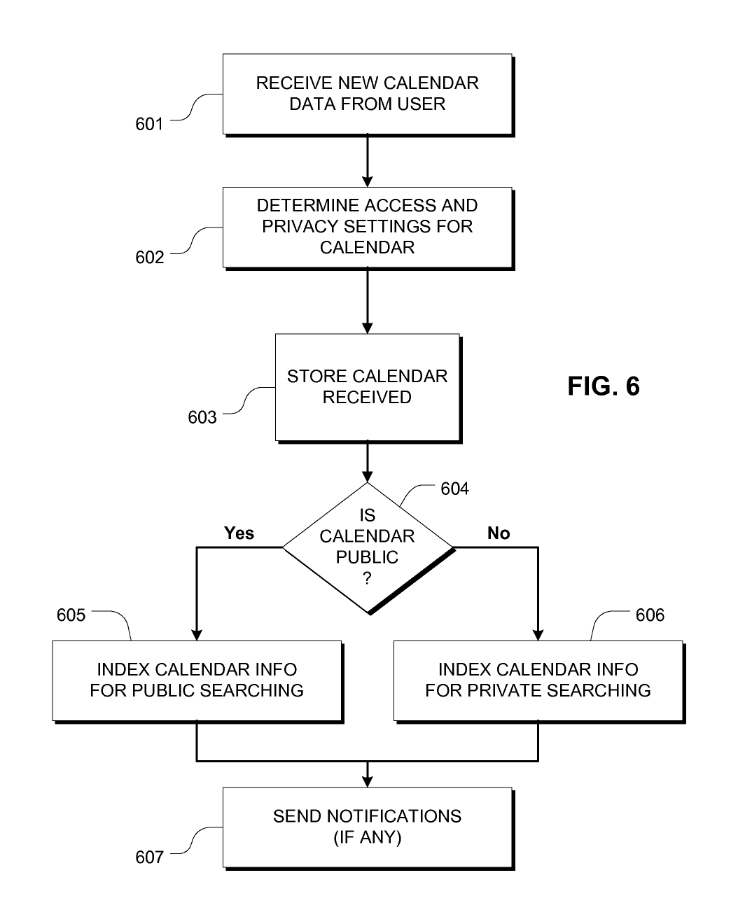

FIG. 6 shows a flowchart of an embodiment of a process of creating a new calendar. This process may be invoked when a user selects an appropriate user interface element on interface 201 of FIG. 2, or by other means.

At step 601, the system receives new calendar data from a user. The new calendar data may provide information to be associated with the calendar, such as the calendar name, color and location, among other information. At step 602, the system determines access and privacy settings for the new calendar to be created. Calendars may be private or public calendars. A private calendar, generally speaking, would only be visible to certain predefined users on the system. In contrast, a public calendar would generally be visible to all users on the system. For private calendars, access controls, such as which users may be permitted to view the calendar and which users may be able to modify aspects of the calendar, may be specified by the calendar's creator.

At step 603, the system constructs a new calendar data record and stores that record in a data store, such as a database. At step 604, the system determines whether or not the newly created calendar is a public calendar. This determination may be made based on the data received at step 601, among other things. If the new calendar is a public calendar, then at step 605, the calendar data is indexed for public searching. The data to be indexed may include any of the data provided by the users at step 601 or other data constructed along with the calendar record at step 603. The indexing of the data enables the system to quickly identify relevant calendars in response to a search request. In an alternate embodiment, data is not indexed and instead when a user performs a search, the system identifies matches on a real-time basis.

If the calendar is not public, then at step 606, the calendar may be indexed for private searching. This allows for users with access to the calendar, such as the creator of the calendar or other users such as those specified at step 602, to search for this calendar. The indexed data, for either public or private searching, may include any or all of the following, among other items: words in the title or description, keywords, dates, categories, and location-based information such as geographic coordinates, an address, a position on a geographic grid, and the like.

At step 607, the system sends out notifications in response to the creation of this new calendar. The notifications may be sent to users based on indicated interest in the calendar and related calendars in the creator of the calendar or in parameters associated with the calendar. For example, a user may provide a set of search terms to the system and requests to be notified any time a new calendar or event is created that matches the provider parameters. Upon creation of the calendar or at some other predetermined time, the system may determine that this newly created calendar matches the user-provided parameters, and send notifications to the user, indicating that this new calendar has been created, thus facilitating the user in discovering and possibly following this new calendar.

The steps of indexing the calendar information 605 and 606 may be done either in real time or in predetermined batch processing. In an embodiment, the data is indexed immediately upon creation of the new calendar at step 603. Such an embodiment has the advantage that users are immediately able to discover the newly created calendar. In an embodiment, the data is indexed on a periodic basis, such as once every hour or once every day. Such an embodiment has the advantage that multiple data entries may be indexed at the same time, thus potentially saving time and processing power required for indexing.

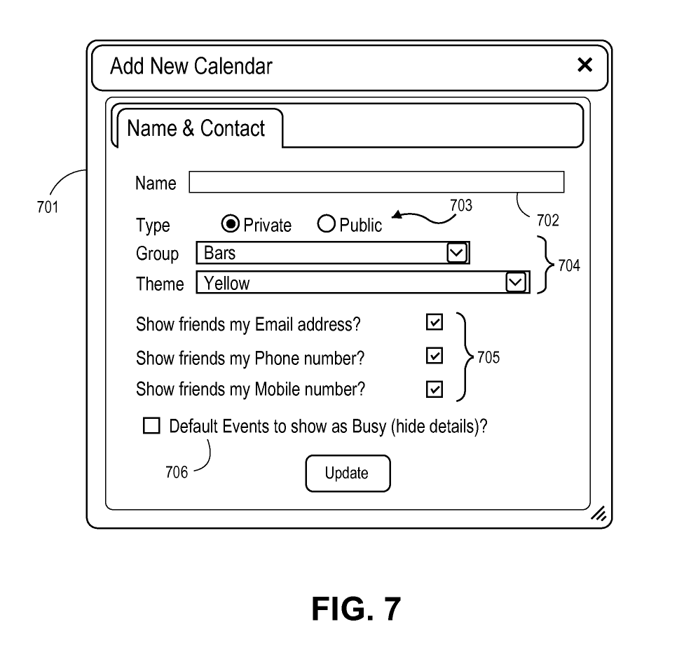

FIG. 7 is an embodiment of a user interface for adding a new calendar. The user interface may be shown as a pop-up window, as described previously. Window 701 includes information to be provided for the new calendar, such as the name of the new calendar 702, whether the calendar is public or private 703, a group, theme, and/or color 704, and privacy settings 705. The privacy settings may be used to indicate whether other users viewing the calendar to be created are able to see certain profile information about the creator of the calendar. Additionally, the user may be able to specify, using user interface element 706, whether to display details about a particular event. In an embodiment, when element 706 is selected, then events on the calendar will by default be marked as “busy,” so certain users may be able to see some information on events in the calendar but not other information. In an embodiment, users with read-only access are only able to view the times and dates of events marked as “busy” so as to know that the person or venue is unavailable at that time, but not see the title, description, or other information about the event. This may be useful, for example, for a user who wishes to create a calendar that shows whether or not the user is busy at certain times but does not reveal what the user will actually be doing that that time. In an embodiment, individual calendars may be set up to display all to hide the details of all events. In an embodiment, individual events, as created by the user, may further be selected to have their details hidden to other viewers.

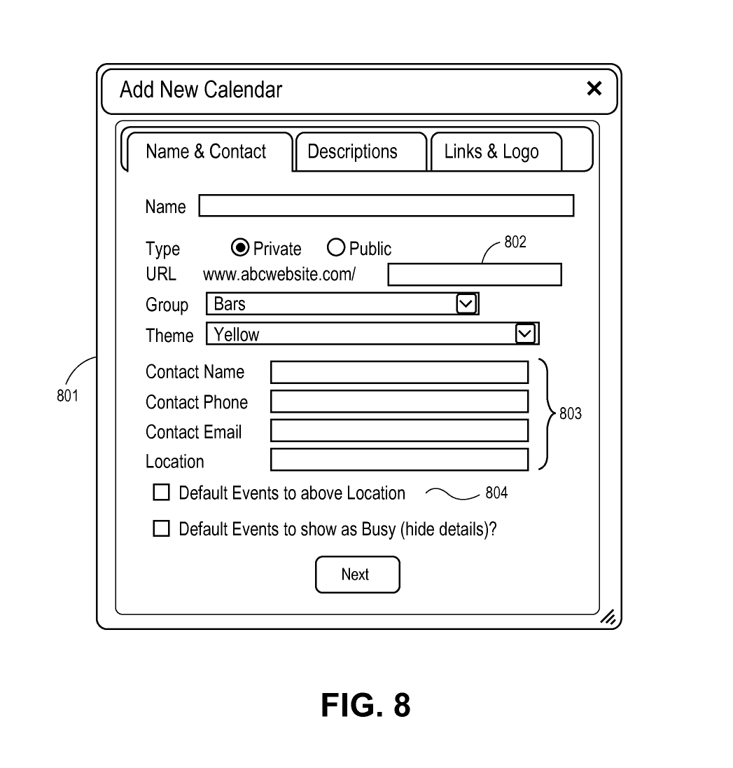

When the user chooses to create a public calendar, then window 801 of FIG. 8 may be shown to the user. In particular, additional information may be requested. Such information may include a URL for the calendar 802. The URL may be used by external parties to easily view the calendar without having to navigate the calendar system first. In an embodiment, when a user creating a new public calendar specifies a URL for the calendar, in element 802, the system automatically checks whether that URL has been used by another calendar and if it has, then the user is automatically notified so that a new URL may be selected.

Additionally, the creator of the public calendar may specify contact information and location information to be associated with the calendar, using elements 803. Furthermore, the calendar may be set such that all events are associated by default with the specified location, using checkbox 804.

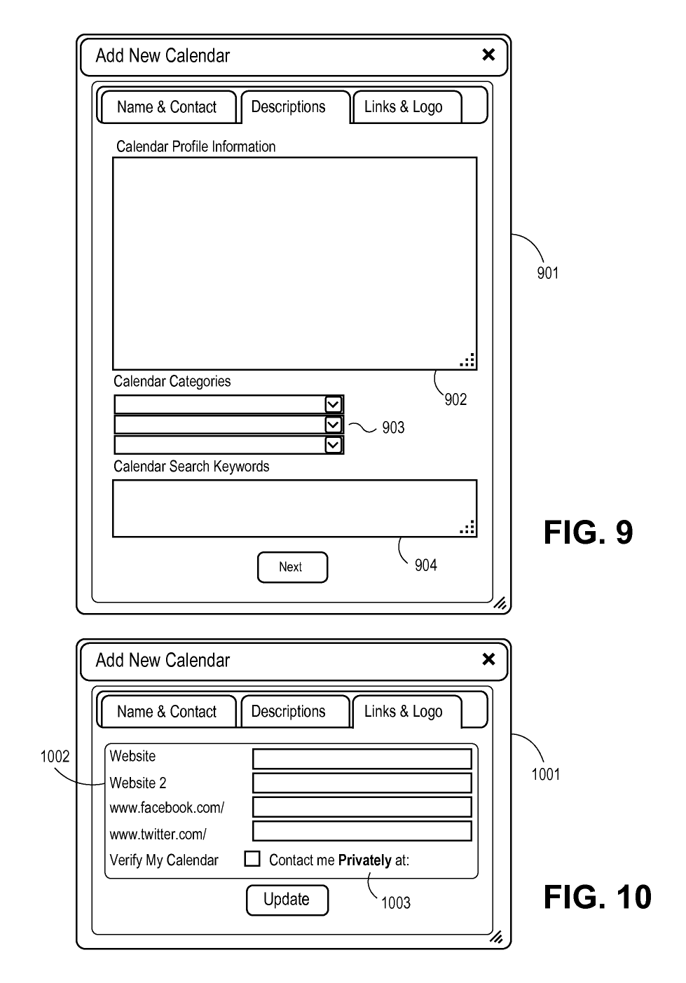

FIG. 9 shows a window 901 requesting further information to be used in creating a public calendar. For example, calendar profile information or description information may be entered in box 902. Additional information, such as categories or keywords to be associated with the calendar, may be entered in elements 903 and 904. The data provided in these elements may be used, for example, to assist in searching or displaying detailed information about the public calendar.

FIG. 10 shows further information that may be requested in creating a public calendar. Window 1001 includes elements 1002 for entering information, such as a website and/or related web pages. Element 1003 allows a user to request that a public calendar be verified. When the user selects this element, the user is provided with several input boxes for providing personal contact information. The system then performs various identity checks to confirm the identity of the person creating this calendar. These identity checks may include manually contacting the person or automatically retrieving personal information about the person, such as the person's credit report or credit history. If the person is successfully verified, then the system may inform viewers of the calendar of the verification, for example by placing a notice or badge near the calendar name.

In an embodiment, the information requested as shown in FIGS. 8-10 may be requested on separate pop-up windows or user interface elements. In another embodiment, all of the information may be requested on the same window. In various embodiments, additional information or less information may be requested by the system in creating a public calendar. In an embodiment, any of the information requested for creating a public calendar may also be requested in creating a private calendar.

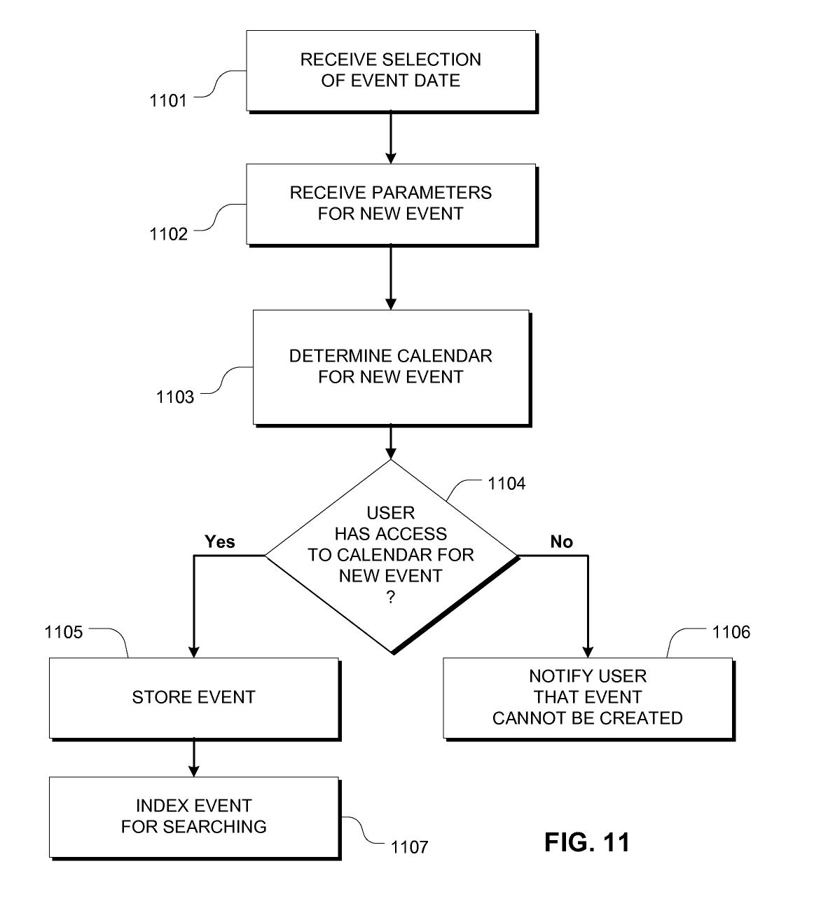

FIG. 11 is a flowchart of a process for creating a new event as used in an embodiment. At step 1101, the system receives a selection of a date for the new event. The selection of the date may occur by a user clicking on a particular date on a calendar. In an embodiment, the date may be provided via a third-party application or website, through a link or through text on a document being viewed, such as an email. In an embodiment, a time to be associated with the event being created is also received at step 1101.

At step 1102, the system receives parameters for the event to be created. These parameters may be received at the same time as the selection of the dates in step 1101 or the parameters may be received subsequent to the selection of the event dates. In an embodiment, the parameters for the new event are received after displaying a user interface requesting the user to provide those parameters.

At step 1103, the system determines one or more calendars to which the event should be added. Because events are not directly associated with calendars but rather are associated with calendars via a link, it is possible for a user to associate an event with multiple calendars.

At step 1104, the system determines whether or not the user creating the event has access to the calendar to which the event is to be added. The determination of whether the user has access may be based on a number of preferences and access settings associated with the calendar. For example, the calendar may have a membership list and associate user access permissions with individual members of the calendar. In such a case, the user may be granted access if the user is provided with “write” permission to the calendar.

If the user is determined not to have access to the specified calendar, then at step 1105, the user is notified that the event cannot be created. If the user does have access to the calendar, then at step 1106, the system creates a record of data for the new event and stores the event. Furthermore, at step 1107, the data associated with the event is indexed for searching. Just as with creating calendars, the process of indexing the event for searching may be dependent on whether or not the event is public or private. As with indexing of calendars, the indexed data, for either public or private searching, may include any or all of the following, among other items: words in the title or description, keywords, dates, categories, and location-based information such as geographic coordinates, an address, a position on a geographic grid, and the like.

In the case that the event is to be added to multiple calendars, the system performs the determinations of step 1103 and on for each of the calendars to which the event is to be added.

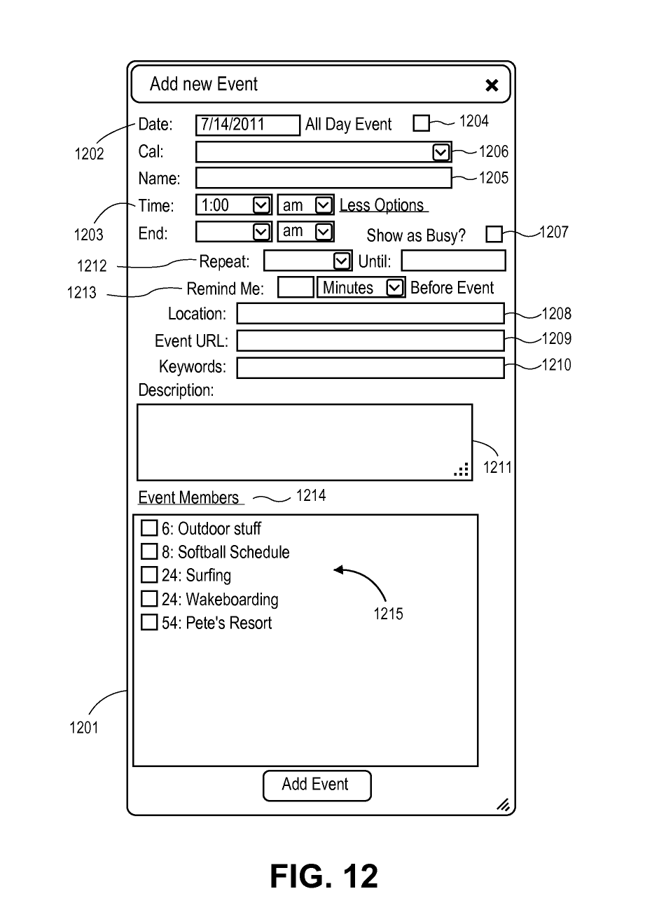

FIG. 12 is a user interface for adding a new event as used in some embodiments. Window 1201 is accessed in an embodiment by clicking on the calendar to create a new event for particular dates. In other embodiments, this interface may be accessed by entering a date or selecting a date by other means of this write throughout the specification. User interface element 1202 may be used to enter the specific dates for the events. The time for the event may be added using element 1203. In an embodiment, the user may specify both a start time and an end time. In other embodiments, the user may specify a start time and a duration for the event as an alternative method of entering the time for the event. In an embodiment, the user may indicate that the event is an all-day event such as by checking box 1204. In such a case, the user may not be required to enter time into box 1203 and the calendar display will indicate that the events occupy the entire day rather than only a particular time.

A name for the event may be entered in box 1205 and the event may be associated with a particular calendar using element 1206. Additionally, the user may provide further information or parameters relating to the event. For example, the user may wish to indicate that the user will be busy during the specified time for the events by selecting box 1207. In an embodiment, this box is automatically checked if the calendar is set by default to show events as busy using a calendar setting as previously described. Additionally, the user may provide information such as the location of the event in box 1208, an associated URL at 1209, and information such as key words or a description for the event at 1210 and 1211. In other embodiments, additional information or less information may be requested to be associated with the events.

In an embodiment, the user may specify that the event is to be repeated on a periodic basis. For example, the event may be repeated once every day, week, month, or year. The user may provide parameters for repetition of the event using interface element 1212 where the user can specify the parameters for repeating the events and a limitation on how many times the event is to be repeated. Additionally, the user may associate a reminder with the event using interface element 1213. For example, the user may wish to receive a notification some minutes prior to the start of the events, and can specify that duration using these interface elements. In an embodiment, the user is further able to select a type of notification using an associated interface element. For example, the user may be reminded by text messages, e-mails, a pop-up window on the user's computer, and so on.

Interface element 1214 enables the user to specify members to be associated with events. The members may be, for example, other users who have permissions to view, modify or administer the particular events. In an embodiment, selecting element 1214 opens a pop-up window or other interface element that enables the user to enter the members for an event. In an embodiment, the event members are set by default to be based on the members for one or more calendars associated with the event. Additionally, in an embodiment the user may specify groups of users or categories of users, based, for example, on user profile characteristics or social network relationships, or based on the specifying user's own choosing.

Interface element 1215 enables the user to link the event to be created to one or more calendars. Element 1215 includes one or more check boxes corresponding to the calendars associated with the user's accounts to which the user has permission to add events. The event is linked to the selected calendars. In an embodiment, the system requires that a newly created event be linked to at least one calendar, and presents an error message should the user select no calendars.

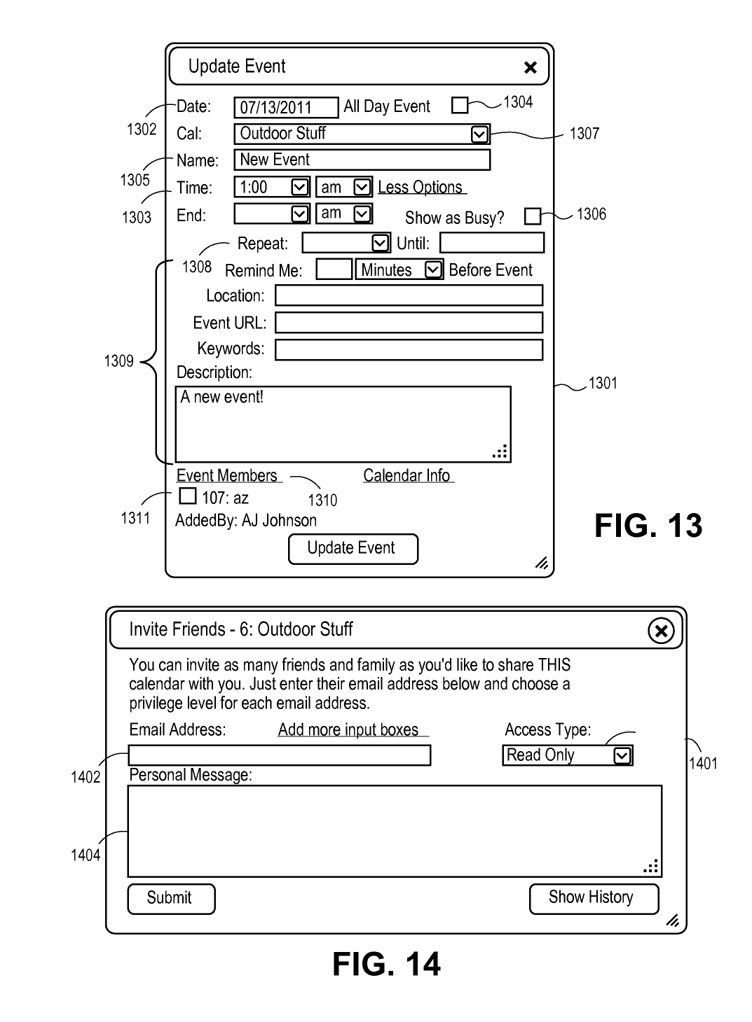

FIG. 13 shows a window for providing information for updating an event as used in an embodiment. Window 1301 may be accessed by selecting a particular, existing event displayed on a calendar interface presented to the user. In an embodiment, the system determines whether the user has permission to update an event and only displays window 1301 where the user has permission to update the event.

Interface element 1302 enables the user to modify the date for the event. Element 1303 enables the user to modify the time for the event and element 1304 enables the user to change whether or not the event is an all-day event. The user may further modify the name of the event using element 1305 and modify whether the event to be shown as busy using element 1306. In an embodiment where the user opts to show the event as busy, the system configures the event such that other users viewing the event are not able to view particular details about the event. In other embodiments, if a user indicates that an event should be shown as busy, the system configures the event to place a message on any displays of the event indicating that the user will be busy at a specified time.

In an embodiment, events are associated with a primary calendar which is selected at the time of creation of the event. In certain embodiments, the associated primary calendar is fixed such that it is displayed at element 1307 but cannot be changed. In another embodiment, a user is able to change the primary calendar associated with a particular event.

Interface elements 1308 enable the user to adjust the repetition parameters for events and interface elements 1309 allow the users to modify information associated with the event such as location, URL, and description. Furthermore, the user may adjust the members or users associated with an event using interface element 1310. The user may also adjust the calendars to which the event is linked using listing element 1311.

FIG. 14 shows an embodiment of a user interface for inviting other users on the calendar system to share a calendar. Window 1401 is displayed when in response to a user submitting a request to invite friends to a calendar. This may be done using interface elements associated with individual calendars. When a user invites friends to a calendar, the friends may be sent notification messages and provided with instructions on how to add the calendar to their account, so that they may share the calendar.

Interface element 1402 enables a user to provide an e-mail address for a user to be invited to a calendar. Other contact information may alternately be used. Element 1403 allows the user to specify a privilege or access level for the user being invited to the calendar. In an embodiment, the available access types are read-only, read/write and administration. A user with permissions to only read a calendar may view events on the calendar. A user with read/write permissions may also add events to the calendar or modify events on the calendar. An administrator to a calendar may also be able to invite users and modify users' access permissions to the calendar. In an embodiment, fewer or additional forms of access may be provided, as known to those of skill in the art.

Element 1404 enables the user to provide a personal message to be sent to the individual identified in element 1402. In an embodiment, further information, such as inviting user's personal information, may be included in the notification. In additional embodiments, further information may be requested of the inviting user, such as whether the inviting user wishes to provide certain personal information in the notification message.

In an embodiment, users other than the creator of a calendar are able to invite users to a calendar. For example, as described previously, users with administrator privileges may be able to invite users to a calendar. Additionally, in an embodiment, a user with read access to a calendar or read/write access to a calendar may be able to invite users to a public calendar, thus enabling the public calendar to be shared with further individuals.

In an embodiment, the privilege level that an inviting user is able to provide to a new user using, for example, interface element 1403, is limited by the user's own access permissions to a calendar. So, for example, if a user only has read/write access to a calendar, that user may be able to invite another user to a calendar, such as a public calendar, but the user will not be able to invite other users as administrators to the calendar. In an embodiment, when a user invites another user to a calendar, the privilege level for the user being invited may be no higher than the privilege level of the user sending the invitation. In an embodiment, further restrictions on the ability for inviting users to provide access permissions to new users, may be restricted by an administrator of a calendar or an administrator of the calendar system.

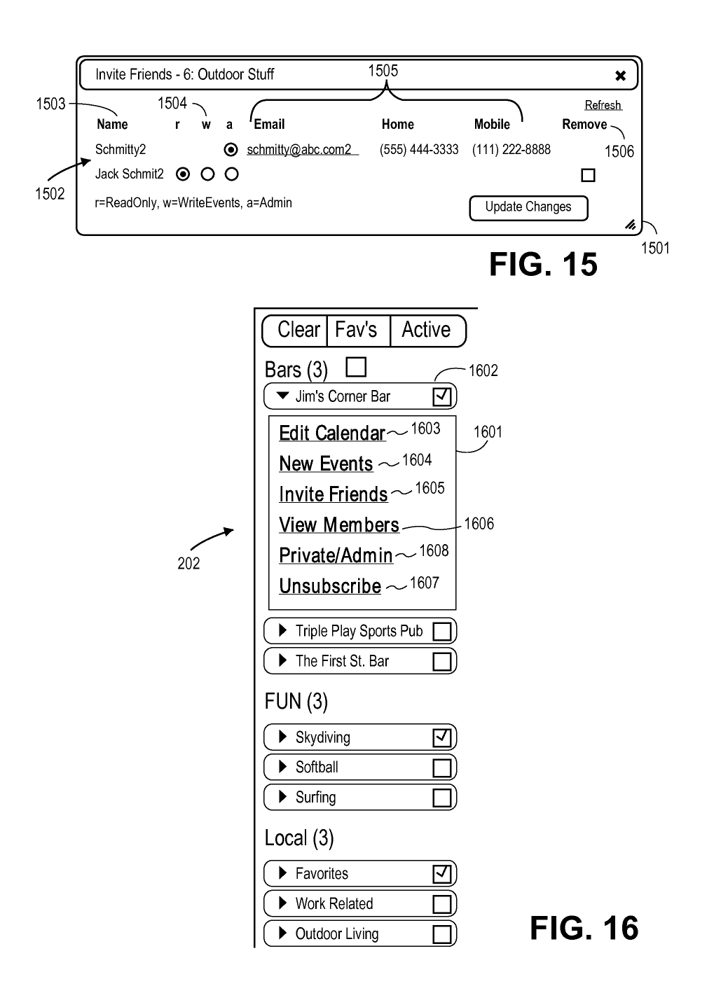

FIG. 15 is a user interface for managing the members of a calendar as used in an embodiment. Window 1501 may be displayed in response to a user selecting an appropriate interface element on a calendar to modify the membership of a calendar such as through the update events window shown in FIG. 13. Window 1501 includes a listing of users associated with the calendar 1502. In an embodiment, the listing is presented as a table. The table may include user names 1503, access permissions 1504, contact information of the members of the calendar, 1505, and an option to remove users from a calendar 1506. In an embodiment, window 1501 may be used to modify membership associated with a particular event rather than a particular calendar.

FIG. 16 is a detailed view of the calendar listing such as that in element 202 of FIG. 2. Element 1601 is displayed in response to a user interacting with a particular calendar listing such as by clicking on calendar listing element 1602. Upon the user performing the specified interaction, a number of options may be displayed for managing the particular calendar. For example, an option for editing the calendar 1603 may be shown. Additional options include viewing new events recently added to the calendar 1604, inviting friends to a calendar 1605, viewing the members for a calendar 1606, and unsubscribing from a calendar 1607.

In an embodiment, when the user selects interface element 1603, a window similar to that shown in FIGS. 7-10 may be displayed, enabling the user to adjust parameters associated with the calendar. In an embodiment, when the user selects element 1604 to add new events, a window such as that shown in FIG. 12 may be displayed. In an embodiment, where the user selects element 1606 to view members for a calendar, a window such as that shown in FIG. 15 may be displayed.

In an embodiment, the listing of calendar options 1601 includes a display 1608 indicating whether the calendar is private or public and the access level that the user has for the calendar. Additional information about the calendar or less information about the calendar may be presented in listing 1601. In an embodiment, the information in listing 1601 depends on the user's access permissions to the calendar. For example, if the user only has read access to a calendar, elements 1603, 1604, and 1605 may not be shown to that user. Similarly, if a calendar is a public calendar and the user only has read access to the calendar, element 1605 may be shown, but elements 1603 and 1604 may not be shown.

In an embodiment, the window shown when the user selects the various interface elements in listing 1601 may be tailored based on the user's permission level for the calendar. For example, the membership listing displayed when the user selects element 1606 may allow the user to modify access levels for the calendar if the user is an administrator to the calendar, but it may provide no options for modifying access levels otherwise.

In an embodiment, calendar listing 202 may be displayed on the main calendar interface for example, as displayed in FIG. 2. The calendar listing 202 may be shown on the side of the calendar, above the calendar, or other locations on the display. In an embodiment, the interface elements may be hidden, for example, when the user selects a button on the window to hide or display the calendar listing. In the embodiment, calendar listing 202 may be shown in a separate window, page, or tab.

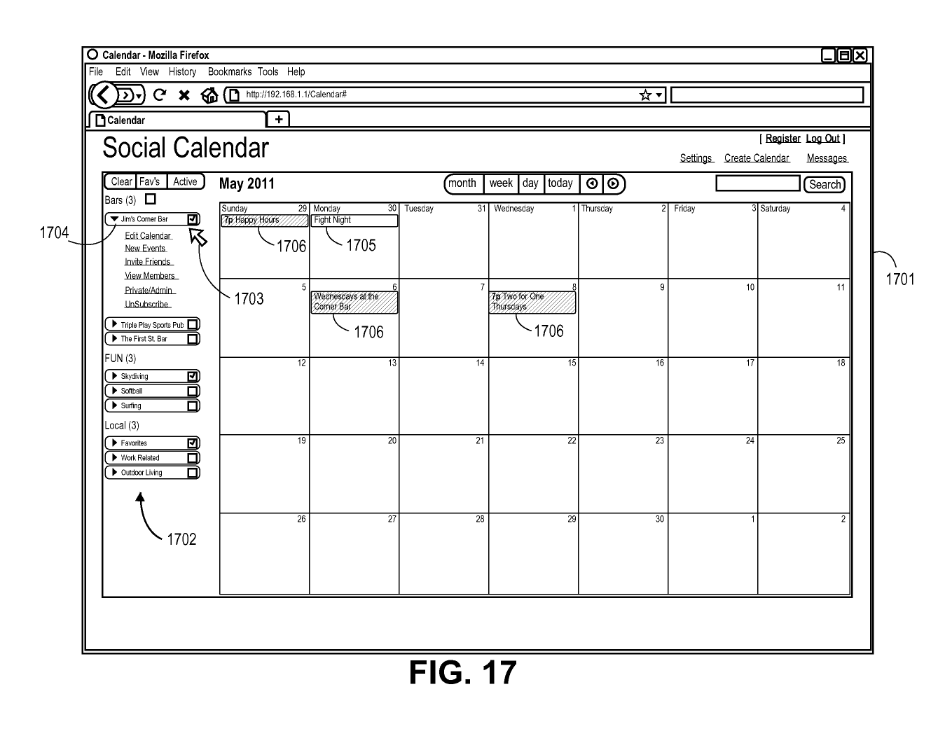

FIG. 17 shows a sample user interface in which a user interacts with the calendar listing. Window 1701 includes a calendar listing 1702 in which a mouse cursor 1703 is placed over a particular calendar 1704. In the calendar display, events associated with calendar 1704, such as event 1705, are highlighted in one color, but events not associated with the calendar, such as event 1706, are displayed in a different color. Such a system enables the user to quickly highlight events associated with a particular calendar.

When an event is associated with multiple calendars, that event may be highlighted, in response to the user interaction, if the calendar selected by the user is any of the calendars linked to the event. For example, if event 1705 were associated with calendar 1704 and other calendars, it would be highlighted. The user interface may include further graphical indications of the fact that event 1705 is associated with multiple calendars. For example, event 1705 may be displayed using multiple colors to indicate its association with multiple calendars. In one embodiment, events 1706 are shown in a neutral color such as gray to reduce their visibility, while events 1705 are shown in a brighter color to increase their visibility. In an embodiment, the color of event 1705 matches the color of calendar 1704. In other embodiments, other graphical or non-graphical indications may be used, such as bold text, flashing, different fonts, drop shadows, or the like.

In an embodiment, the interaction for highlighting events of a particular calendar, as described above, is a mouse-over interaction in which the user hovers the mouse cursor 1703 over a calendar item 1704. In an embodiment, the event highlighting as described above, is performed only when the mouse is hovered over a certain portion of the calendar event such as the check box of calendar 1704. In an embodiment, other interactions may be used such as clicking or dragging the calendar to a particular location. In an embodiment, multiple calendars may be selected for highlighting rather than just one. In an embodiment where there are numerous events on a particular day, the events of that day may be reorganized when the user interacts with a particular calendar, such that an event that may have previously been obscured is now shown.

In an embodiment, the events of a calendar are highlighted according to the following process. The method may be performed either at the calendar system, or it may be performed on a client computer based on executable instructions, such as JavaScript code, received from the system. First, the system detects an interaction from the user, such as a mouse-over interaction, a click, a selection, or the like. The interaction is determined to be associated with one or more calendars. In response, the system identifies the events that are being displayed on the user's display, corresponding to the one or more calendars. The system further determines the events displayed that do not correspond to the selected calendars. The system then updates the user interface to color the events corresponding to the selected calendars with one color, and to color the events not corresponding to the selected calendars with another color. Variations in this method may be performed in various embodiments of the system as described above.

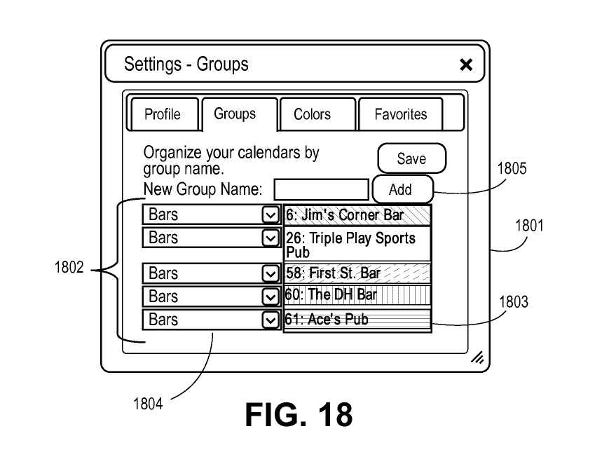

FIG. 18 shows a user interface for assigning calendars to groups as used in an embodiment. Because users may have numerous calendars associated with their accounts, it may be helpful to allow users to organize calendars into groups. In an embodiment, users may organize their calendars using tags, key words, search terms, or other parameters. In an embodiment, the user may be restricted to placing each calendar in exactly one group. In an embodiment, the user may place a calendar in multiple groups or in no group.

Window 1801 includes a listing of the user's calendars 1802. For each calendar in listing 1802 such as calendar 1803, the user may be presented with interface elements such as a drop-down box 1804 where the user may select a group to be associated with the calendar. Additionally, the user may add new groups using interface element 1805. In an embodiment, the calendars are shown using the colors associated with the calendar, to assist the user in identifying particular calendars.

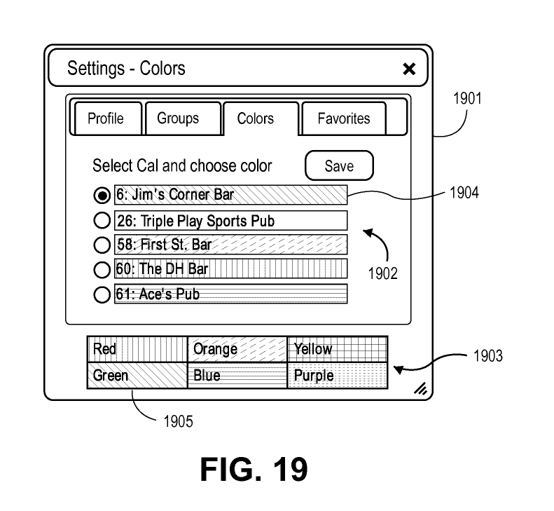

FIG. 19 shows a user interface for associating calendars with different colors. Colors provide users with a further mechanism for organizing and visualizing calendars, further increasing the usability of the system. Window 1901 includes a listing of calendars 1902 and a listing of colors 1903. The user may select a particular calendar such as calendar 1904, and then select a color 1905 to associate it with that calendar. In an embodiment, upon selecting a color 1905, the display for calendar 1904 is updated in real time to reflect the new color selection. In an embodiment, other parameters may be specified for calendars, such as font, text size, text color, graphical background image, and so on.

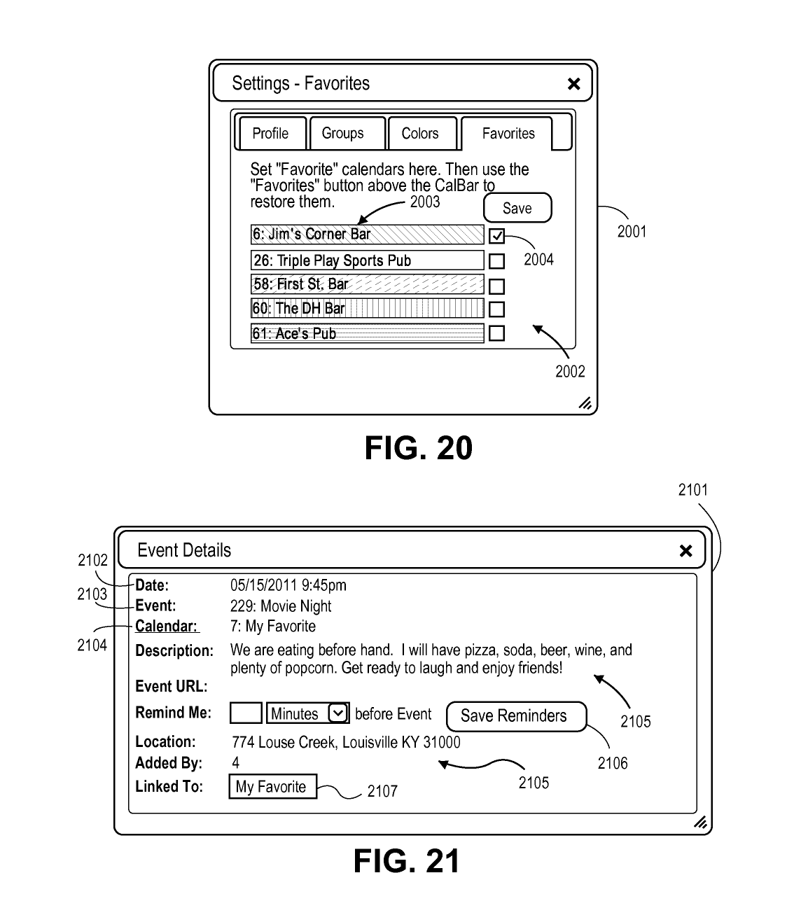

FIG. 20 shows the user interface for selecting certain calendars as favorite calendars and as used in the embodiments. Window 2001 includes a listing of calendars 2002. Each calendar listed in listing 2002, such as calendar 2003, includes a checkbox 2004. When the checkbox 2004 is selected, then calendar 2003 is placed into a favorites group. The favorites group may easily be selected by selecting appropriate interface element on the main calendar display such as element 205 of FIG. 2.

In an embodiment, the user has exactly one set of favorites and may add to or remove calendars from that set of favorites. In another embodiment, the user may have multiple sets of favorite calendars and be able to add or remove calendars from any of those sets of favorites. This would enable the user to quickly and easily toggle between various sets of calendars.

In an embodiment, the listing of calendars 2002 is organized based on the grouping of calendars as previously specified by the user. In an embodiment, calendars are organized alphabetically or by other means. In an embodiment, the calendars listed in listing 2002 are colored based on the color previously selected by the user.

FIG. 21 shows a user interface displaying information about a particular event. Window 2101 may be displayed in response to selecting an event, for example, by clicking on the events, or by accessing a particular URL associated with the events.

Details of an event that may be displayed in window 2101 include the date 2102, name 2103, primary calendar 2104, and additional information 2105. In an embodiment, the user may request a reminder prior to the start of the event such as by using interface elements 2106. In an embodiment, the reminder information may be specified by default by the creator of the event or the creator of a calendar associated with the events. In other embodiments, default reminder parameters may be provided by a user inviting another user to an event. In an embodiment, the calendars with which an event is linked on a user's account are shown in interface element 2107. This provides the user with quick access to information about associations between events and calendars. In an embodiment, element 2107 may be organized based on the groups specified by the user, and the calendars in element 2106 may be colored in accordance with the calendar colors specified by the user.

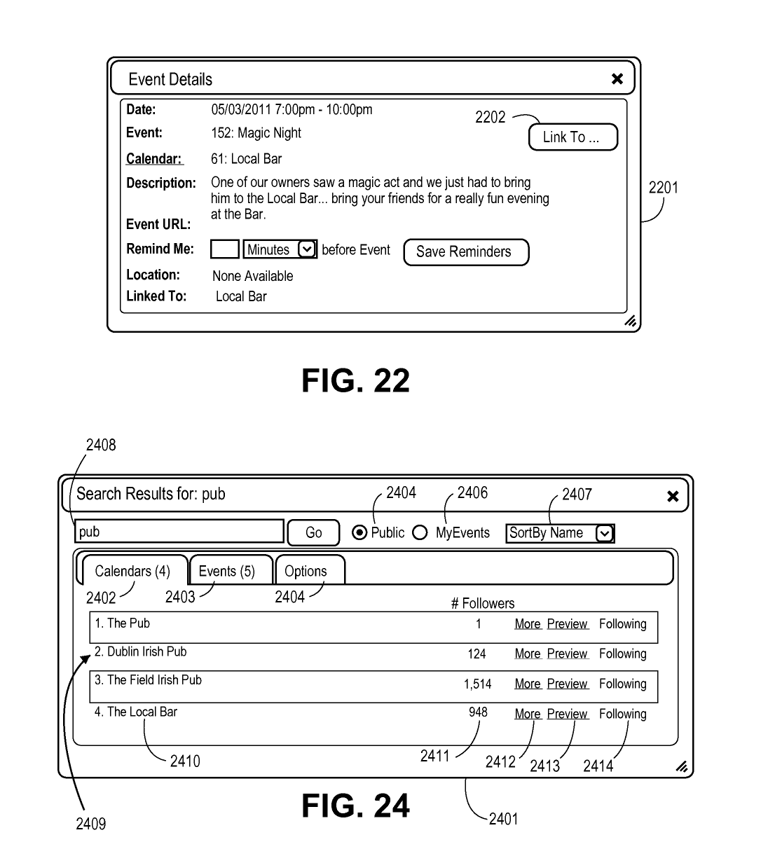

FIG. 22 shows additional embodiments of the user interface showing details about an event. In particular, window 2201 may be shown when a user displays information about a publicly accessible event or an event to which the user has permission to link the event to other calendars. Window 2201 includes a button 2202 that enables the user to link the event to the user's calendars.

In an embodiment, button 2202 is only displayed where the user has permission to link the event to any of the user's calendars. In some situations, the user may have the ability to review details about an event but may not have permission to link the event to additional calendars. This may be the case, for example, with an event on a private calendar, as the creator of the private calendar may not wish to allow details about events to be made public through a link on a public calendar. In an embodiment, the user may have permission to link an event to some calendars, but not to all calendars associated with the user's account. In such a case, the link to button 2202 may be displayed but the resulting user interface when the user selects button 2202 may be limited such that the user is only able to link the event to calendars where the user has appropriate permission to do so.

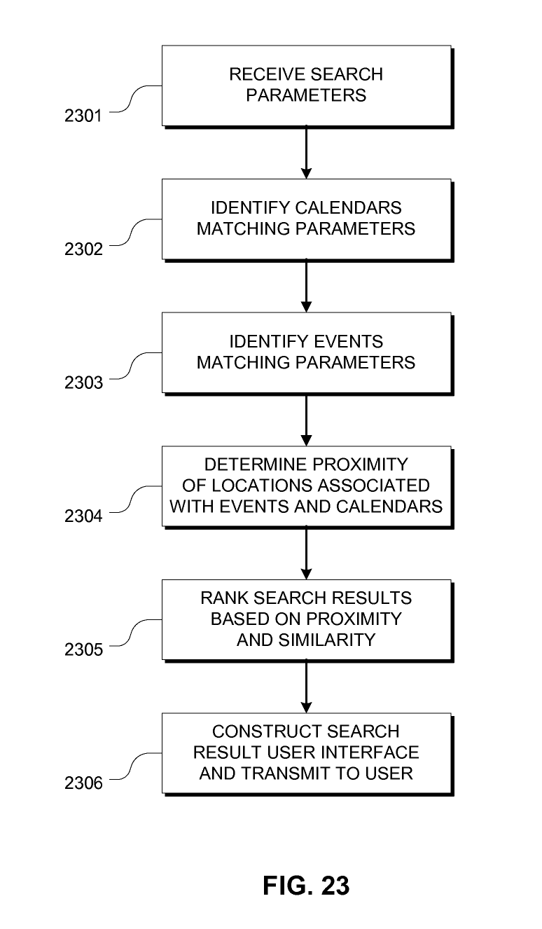

FIG. 23 is a flowchart of a process for searching for events as used in an embodiment. Users may wish to search for events to discover new upcoming events or to discover new upcoming events that the user has not previously learned about or to find events on the user's calendar where the user has too many events to quickly read through all of them. Thus, the search feature is useful both for discovering new events and for managing events already associated with the user's account. At step 2301, the system receives search parameters provided by the user. The search parameters may include certain terms to search for, a location to search for, and whether or not to search public calendars as opposed to just the user's own calendars.

At step 2302, the system uses the received search parameters to identify calendars matching the search parameters. The identification of matching calendars may be done using any number of search algorithms. For example, calendars containing key words matching search parameters provided by the user may be identified by the system. Additionally, calendars associated with the location may be compared to a location provided under the search parameters to determine the distance between the location associated with the calendar and the location provided in the search parameters.

At block 2303, the system identifies events matching the search parameters. Identification of the events may be done using search techniques similar to those used to identify matching calendars. In an embodiment, the process shown in FIG. 23 only identifies calendars matching the search parameters. In an embodiment, only matching events are identified. In an embodiment, the user may specify, in the search parameters, whether to identify calendars, to identify events, or to identify both.

In block 2304, the system determines the proximity of locations associated with events and calendars. Events and calendars may be associated with a particular location and that location may be compared with a location provided in the search parameters. Such proximity determination may be useful for the user who is searching for an event or a calendar located within a certain distance of the user. For example, a user looking for an upcoming event in the local neighborhood may specify in the search parameters that only events within a certain of miles of the user's home are to be researched. In an embodiment, the location of the user is specified by the user entering an address or other information for the search. In an embodiment, the location of the user may be determined using a GPS system or using a location detection services on a mobile device. In an embodiment, the location of the user may have been previously entered, for example, as a part of the user's profile settings and that location may be used by default for the user's location. Additionally, in some cases, events and/or calendars may not have an associated location. In such a case, the user may be able to specify as one of the search parameters of step 2301, whether to include search results for events and/or calendars that have no associated location. Furthermore, the user may not be required to provide a location in which case step 2304 may not be performed.

In an embodiment, identification of locations is performed according to the following process. Locations associated with events and calendars are indexed according to predefined geographic regions. In an embodiment, the regions are square regions a half mile across, and in alternate embodiments other shapes and/or sizes of regions may be used. When a user provides a location and a proximity for searching, the system calculates all of the geographic regions which fall within the scope of the user's search. Then, the system identifies those events and/or calendars having geographic regions matching the user's search. In an embodiment, the system further calculates the distance between the user's provided location and the location associated with the events or calendars identified by this search algorithm, to further filter the search results to the user's precise search parameters. Other forms of location-based searching, as known to those of skill in the art, may also be used. In an embodiment, a third-party service may be used for indexing and searching of locations.

In step 2305, the identified calendars and/or events may be ranked based on proximity and/or similarity. Such ranking algorithms may include any search ranking algorithms known to those of skill in the art. In addition to the proximity information of step 2304 and similarity between parameters provided by the user in step 2301, other information may be used for ranking calendars and/or events. For example, calendars or events may be compared to other calendars and/or events already associated with the user's account for similarity. For example, if the system determines that a user is particularly interested in one sports team based on the user's calendars or events, then the system may rank calendars and/or events associated with that same sports team more highly. Additionally, the system may consider information about other users who are similar to the user performing the search or who are related to the user performing the search and ranking the search results. For example, if the user performing the search is known to interact with another user on a regular basis, then the system may rank more highly those calendars and/or events associated with that other user when returning the search results. In other embodiments, ranking is based on other factors such as name or date, or the results are not ranked at all.

At step 2306, the system constructs a search results user interface and transmits it to the user. The search results interface may present the identified calendars and/or events using the ranking determined as step 2305. The user interface may enable the user to provide further information or parameters for the search.

FIG. 24 shows a sample user interface for searching for calendars as used in the embodiment. Window 2401 may be shown in response to a user entering a search query into the calendar system, such as through interface element 210 of FIG. 2.

Window 2401 may include tabs for displaying calendars matching the search results using tab 2402, events matching the search results using tab 2403, and further options or advance search parameters using tab 2404. Furthermore, the user may select whether to search all public calendars on the system using interface element 2405, or the user may search only the user's own calendars by selecting interface element 2406. The user may further specify the order in which calendars and/or events are presented, using an interface element such as drop down box 2407. If the user wishes to change the search parameters or search terms, that may be done using interface element 2408.

Window 2401 also includes a listing of matching calendars 2409. In an embodiment, the listing of calendars is limited to a predefined number of calendars and the user may access further search results by selecting an option to display further search results. Listing 2409 includes information such as calendar names 2410, a number of calendar followers associated with the calendar 2411, and further options for displaying information about the calendar 2412. Listing 2409 also enables the user to preview a particular calendar using interface element 2413 and to request to follow a calendar using interface element 2414. In other embodiments, further options or information may be displayed on the search results in listing 2409.

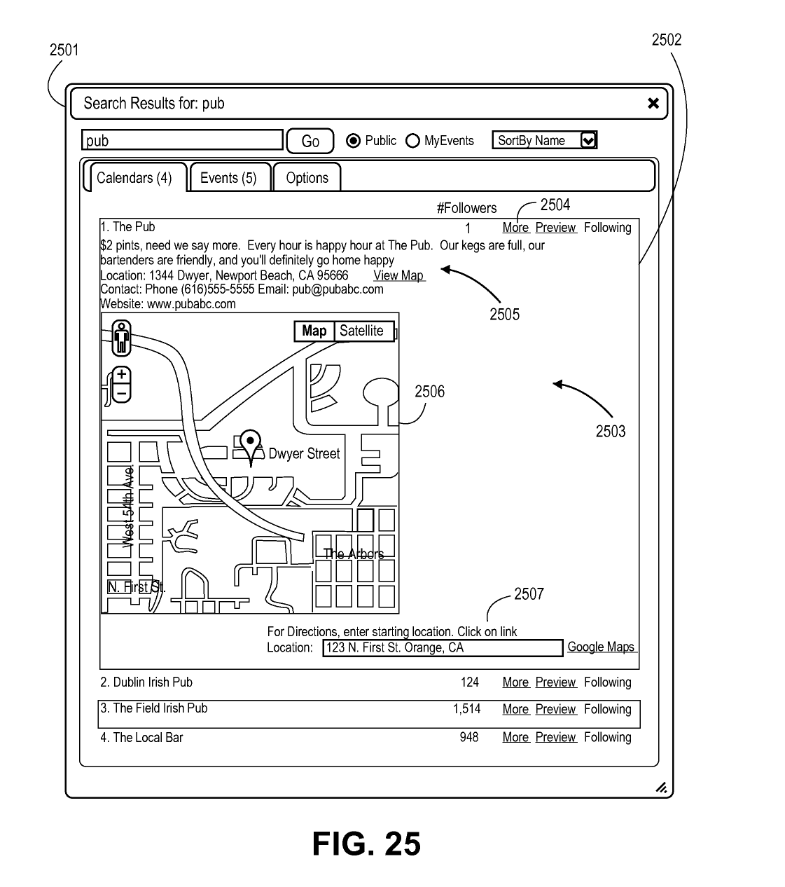

FIG. 25 shows a user interface element of calendar search results including additional information about a particular search results. Window 2501 includes a listing of matching calendars 2402 with detailed information about one particular calendar 2503. This detailed information may be accessed, in an embodiment, by selecting a link 2504 to display more information about a calendar. The additional information may include a further description of the calendar 2505 and a map of a location associated with the calendar 2506. Furthermore, the user may easily calculate directions to the particular location using interface element 2507. This provides the user with convenient access to determining where, for example, the creator of a particular calendar is located, and how the user can get there.

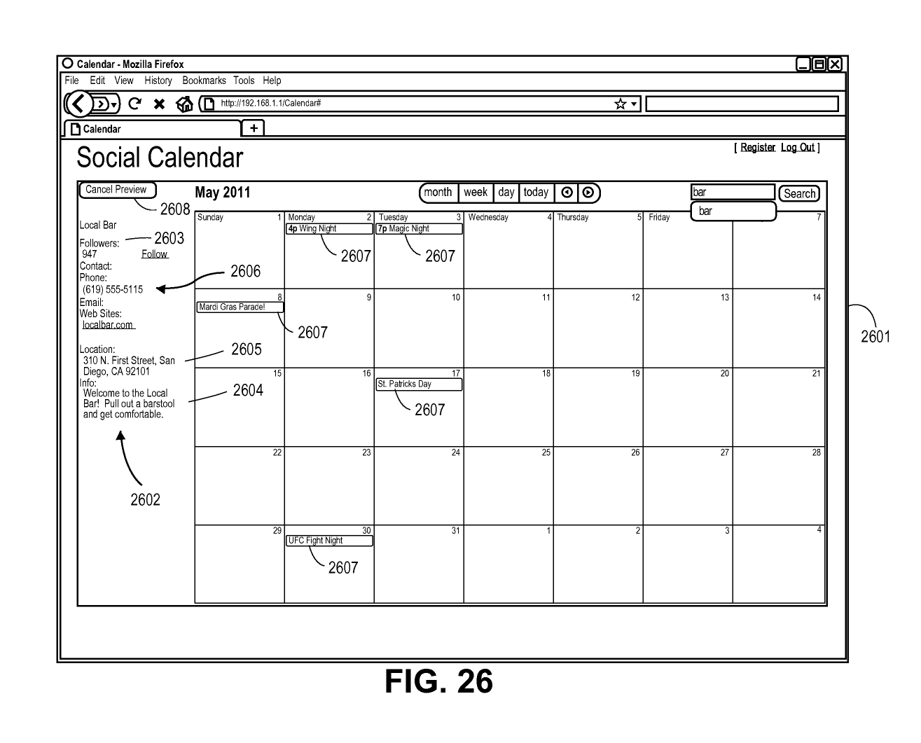

FIG. 26 shows an embodiment of an interface for previewing a calendar. Window 2601 may be displayed based on selecting a preview option in a search result for a calendar such as element 2413 of FIG. 24. Window 2601 is similar in appearance to the general display of the calendar interface such as that shown in FIG. 2. However, window 2601 only displays events associated with a particular calendar being previewed. In another embodiment, both the previewed calendar and the user's other calendars are displayed.

Interface element 2602 may display information about the calendar such as a number of followers 2603, a location 2604, a description 2605, contact information 2606, and other information. In various embodiments, listing 2602 may include additional information associated with the calendar or may include less information. In an embodiment, listing 2602 is located in the place of the calendar listing such as that shown in interface element 202 of FIG. 2. This has the advantage of indicating to the user that the calendar display window 2601 is displaying a preview of the calendar rather than the user's actual calendar. In another embodiment, listing 2602 is shown in addition to the calendar listing. Additionally, a button 2608 enables the user to cancel the preview and return to the default calendar interface for the user. In various embodiments, additional displays of information are used to indicate that a preview calendar is being shown.

Events associated with the calendar being previewed are shown in the calendar display window 2601. Such event 2607 may be displayed at their appropriate times and dates on the calendar. In an embodiment, event 2607 is presented using a color associated with the calendar being previewed. In an embodiment, the color is a default color associated with the calendar unless the user is already following or otherwise associated with the calendar, in which case, the user's selected color is used to display events 2607.

In an embodiment, the user is able to easily link individual events to the user's own calendars through the preview display 2601 without the need to follow or otherwise associate it with the entire calendar. For example, if a user clicks on one of the events 2607, a window for linking that event to one of the user's calendars may be displayed. Such a window may include a listing of all of the user's calendars to which the user may link events. The listing may be displayed in a form such as element 1215 of FIG. 12 or using any other user interface. In an embodiment, clicking on an event shown in a calendar preview may open an event details window such as that shown in FIGS. 21 and 22 to provide the user with additional details about the event and to enable the user to link the event to the user's calendars. In an embodiment, the preview display 2601 graphically indicates which of the events 2607 are already linked to a user's calendar, thus enabling the user to easily determine which events the user does not currently have associated with the user's own calendar.

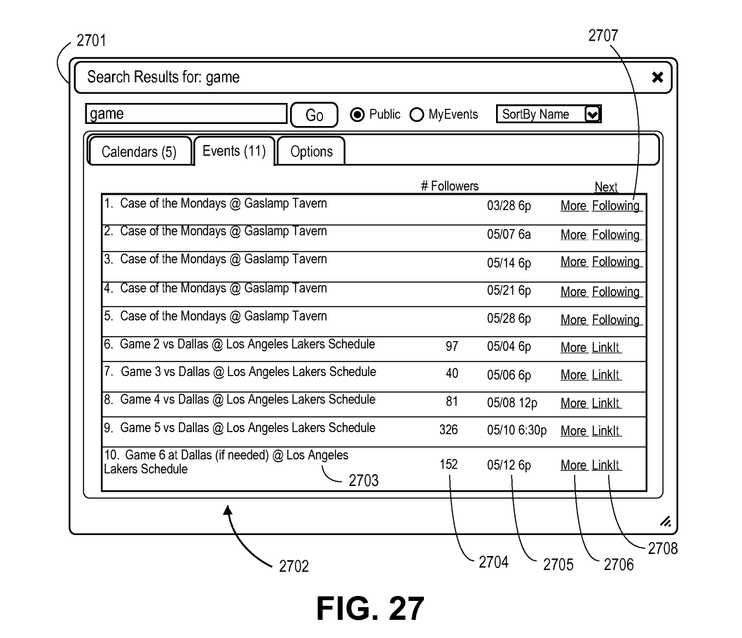

FIG. 27 is a sample user interface showing events matching a user search. Window 2701 may be accessed through means similar to those which the user accesses window 2401 of FIG. 24. From FIG. 24, if the user selects events tab 2403, then window 2701 may be displayed. As shown in window 2701, user interface elements such as the calendars, events and options tabs, and the search options may be included in this window.

Window 2701 includes a listing of matching events 2702 which may be limited based on a predefined number of events to be shown. In an embodiment, listing 2702 includes information such as the names of events 2703, the number of followers for each event 2704, the time and date for the event 2705. Additionally, more information about an event in listing 2702 may be displayed by selecting interface element 2706. Furthermore, if the user is already following an event identified in the search results, then a “following” link 2707 may be shown. In an embodiment, where the user has not already linked an event to any of that user's calendars, then a different interface element 2708 may be displayed. In other embodiments, the same user interface element may be used regardless of whether a user already has an event linked to one of the user's calendars. In other embodiments, additional information may be displayed in listing 2702 or less information may be displayed.

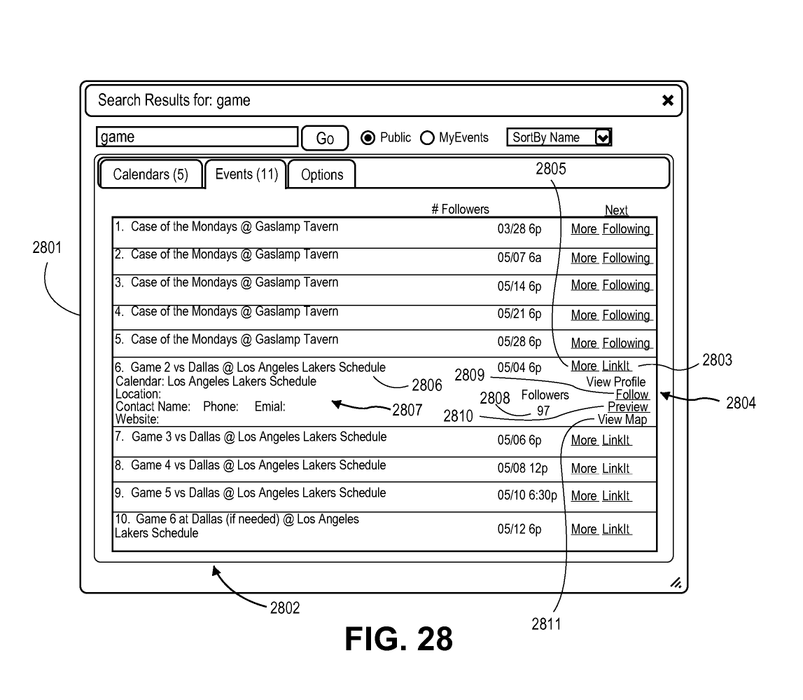

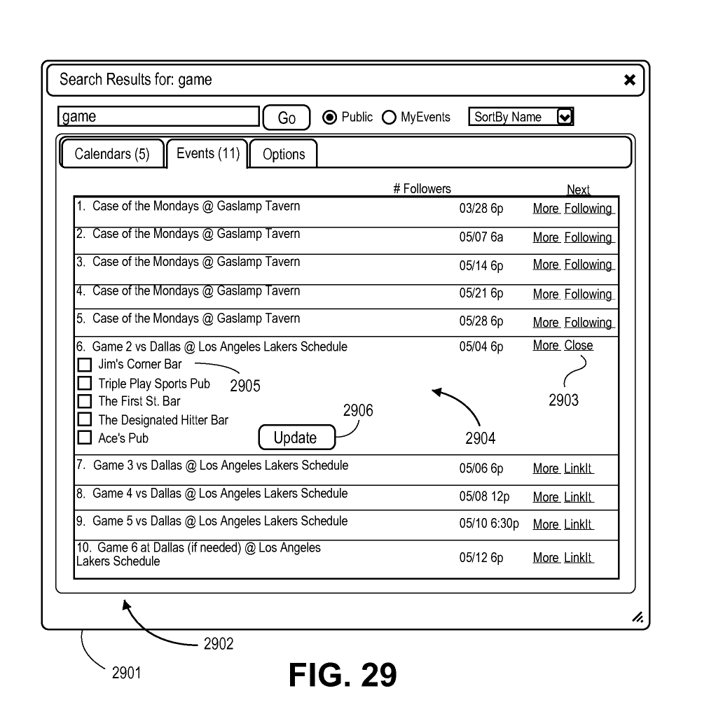

FIG. 28 shows an interface with events matching search results, including additional information about an event, as used in an embodiment. Window 2801 includes a listing of events matching a search query 2802. Search result item 2803 has additional information 2804 displayed. This information may be accessed by selecting link 2805 or by other means. The information may include the primary calendar associated with the event 2806, and location and/or descriptive information 2807. In an embodiment, additional information about calendars linked to the event may be displayed in detail listing 2804.

In an embodiment, further information about followers of the event may be shown in interface element 2808. Additionally, interface may provide controls to follow the event using element 2809, or to preview the event using element 2810. When a user selects element 2810 to preview an event, a user interface with event details such as those shown in FIGS. 21 and 22 may be displayed. In an embodiment, a calendar preview such as that in window 2601 of FIG. 26 may be displayed when the user selects element 2810. In an embodiment, a “view map” element 2811 is displayed, enabling the user to show a map of a location associated with an event, similar to map 2506 of FIG. 25, which may include interface elements for finding directions to the event.

FIG. 29 shows a sample user interface for linking an event identified in a search. Window 2901 includes a listing of search results 2902 in which search results element 2903 includes a listing of calendars 2904 to which the events may be linked. In an embodiment, the listing of calendars may be displayed upon selecting a user interface element such as element 2707 or 2708 of FIG. 27 or element 2809 of FIG. 28.

Listing 2904 may be displayed at the same time as the detailed information listing such as that of element 2804 of FIG. 28. In another embodiment, only one of the detailed listing and the listing of calendars for linking may be displayed at any given time.

The listing of calendars 2904 includes checkboxes for each calendar, such as checkbox 2905, for each of the calendars. The user may select any number of checkboxes 2905 and then select the update button 2906 to link the events shown in search results 2903 to the selected calendars. In an embodiment, the event is linked to calendars immediately upon selection of checkboxes 2905 in which case, the update button 2906 is not required.

In an embodiment, the calendars listed in listing 2904 are all of the calendars to which the user has permission to link the particular event. In an embodiment, the user is provided with features to filter listing 2904 to identify particular calendars such as by calendar groups or favorite calendars as specified by the user previously. Additionally, listing 2904 may include options for sorting the calendars.

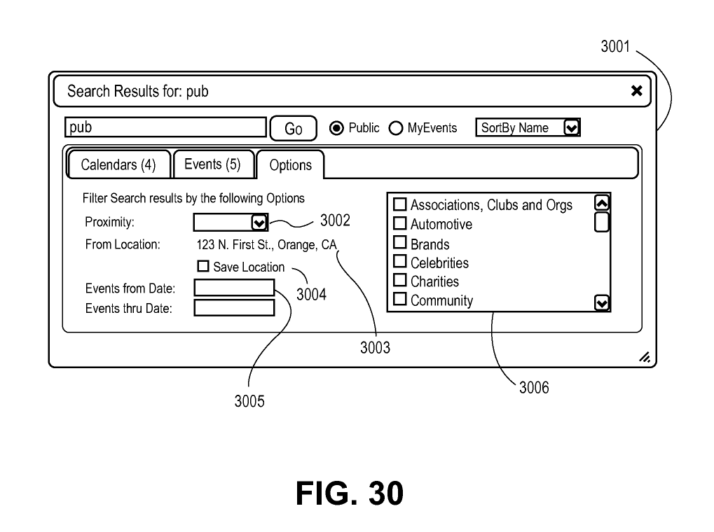

FIG. 30 is a user interface for specifying parameters to a calendar and/or event search. These parameters may be the parameters provided to the process of searching for events or calendars such as the process in FIG. 23.

Window 3001 may be displayed upon selection of tab 2404 of FIG. 24. Additionally or alternatively, window 3001 may be displayed if the user requests to perform an advanced or detailed search. Such an option for advanced or detailed search may be presented on the calendar user interface such as that of FIG. 2 at element 210.

Window 3001 provides a number of options for search parameters. For example, the user may provide a requested proximity for events or calendars to be identified through interface element 3002. The proximity may be specified in a distance such as a number of miles, a driving distance, or a driving time. The driving distance and/or driving time may be calculated based on geolocation or traffic calculation services and may incorporate real time traffic data where such data is available. Additionally or alternatively, such traffic calculations may be based on historical traffic data for a time associated with particular events. Thus, for example, if the system identifies an event occurring on a certain date potentially matching the user's search parameters, the system may calculate a driving route between the event at the user specified location and use historical traffic data to calculate the driving time or travel time between the user's location and the events thus providing a more precise estimation of how long it will take for the user to arrive at the location of the event.

Interface element 3003 allows the user to specify a location from which the proximity is specified and a distance is calculated. This location may be, for example, the user's home or current location. In an embodiment, the location defaults to a home location specified in the user's profile settings. In an embodiment, the location may default to a location calculated using GPS services, mobile device location services, or other location services associated with a computing device of user. In an embodiment, the user may specify a location and save that location using, for example, interface element 3004. In that case, the saved location may be used as a default for future searches performed by the user.

Interface element 3005 allows the user to specify a date range for events to be identified. By default in an embodiment, the system may identify all events occurring subsequent to the current date and time. In an embodiment, the default time period may be pre-defined by the user to be, for example, events occurring within a week of the current time. However, the user may use interface element 3005 to specify particular dates and/or time to search for. In an embodiment, the user may be able to specify a time without the need to specify a particular date. This may be useful, for example, if the user is looking for something to do at night without having to specify which day of the week the user wants to search for. In an embodiment, the system may be able to search for dates using other forms of input, for example, the user may wish to search for events occurring only on weekends.

Additionally, the search interface of window 3001 may enable the user to search for certain categories of events and/or calendars. An interface element such as list 3006 may include one or more categories of events and/or calendars. Calendars and events may be associated with these categories by the creators or other users who modify the events and calendars. For example, categories for calendars may be specified by creators or modifiers of calendars using interface elements 903 of FIG. 9. Similarly, events may be associated with categories to enable detailed searching.

Additional factors that may be considered in searching for events and/or calendars may include events or calendars being followed by users associated with the searching user, such as the user's friends, and other events of interest associated with the account of the searching user. Window 3001 may provide further interface elements for specifying whether such factors should be considered in the searching process.

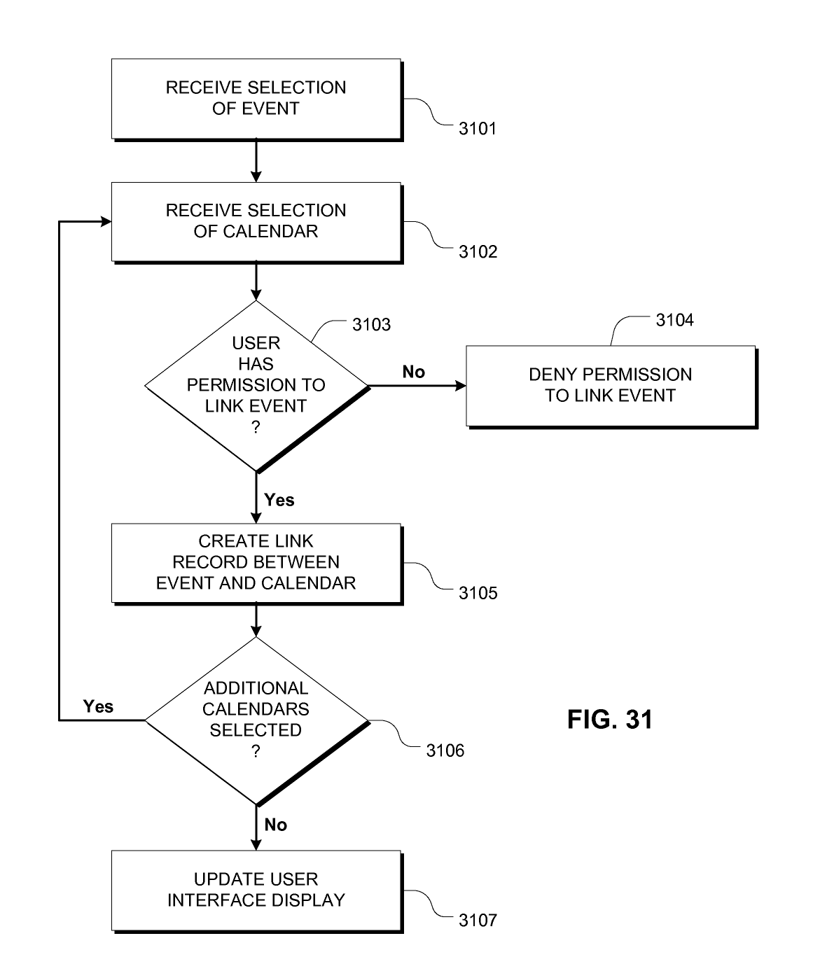

FIG. 31 is a flowchart of a process of linking an event to one or more calendars. This process of linking an event to calendars may be invoked in any number of situations through any number of user interfaces presented by the system. For example, events may be linked upon or immediately after creation of the events using interface element 1215 of FIG. 12. Alternately, events may be linked to calendars through the event details display using element 2202 of FIG. 22 or events may be linked to calendars when those events are discovered through searches using listing 2904 of FIG. 29. Additional opportunities for linking events to calendars may be presented by other user interfaces of the system.

At block 3101 an event is selected by the user. The event may be selected by the user through any number of means, such as clicking on an event, accessing a URL associated with the event, or identifying the event through a search process. Additionally, the selected event may be an event that has been newly created.

At step 3102 a calendar to be associated with the event is received. The calendar may be selected by the user or it may be specified when the user accesses a particular URL for linking a calendar and an event. Some user interfaces may enable the user to select more than one calendar, in which case the process described herein may be repeated for each of the calendars.

At step 3103 the system determines whether the user has permission to link the selected event to the selected calendar. The determination of whether the user has permission to link the event to the calendar may be based on information relating to the calendar and information relating to the event. For example, if the user does not have permission to modify the calendar, then the user will not be granted permission to link the event to the calendar. Additionally, if the user is determined not to have permission to link the event to other calendars, then the user will also be denied permission to link the event to the calendar. This may be the case if the selected event is on a private calendar for which the calendar creator or other administrator has not granted permission for events to be linked to other calendars, to ensure privacy of the calendar. If the user is not granted permission to link the event to the calendar, then the user is denied permission and a notification may be provided or transmitted to the user to indicate that permission has been denied at step 3104.

If the user is determined to have permission to link the event to the calendar, then at step 3105 a link is created to record the connection between the event and the calendar. The link may be a data structure such as link 504 of FIG. 5. Additionally, further information, such as calendar-event preferences 505 of FIG. 5, may be created in association with the newly created link. In an embodiment, the system receives information about parameters to be associated with the link, such as color or organization preferences, and associates those selected preferences with the created link at step 3105.

If the user selected multiple calendars at step 3102, then at step 3106 the process repeats to determine permissions and to link the further selected calendars. Once all of the calendars have been processed, then at step 3107 the user interface display is updated. The updates may include showing the newly linked event, the user's calendar display, changing the colors of the event as displayed on the calendar display, and updating information shown about the calendar reflecting the newly linked event.

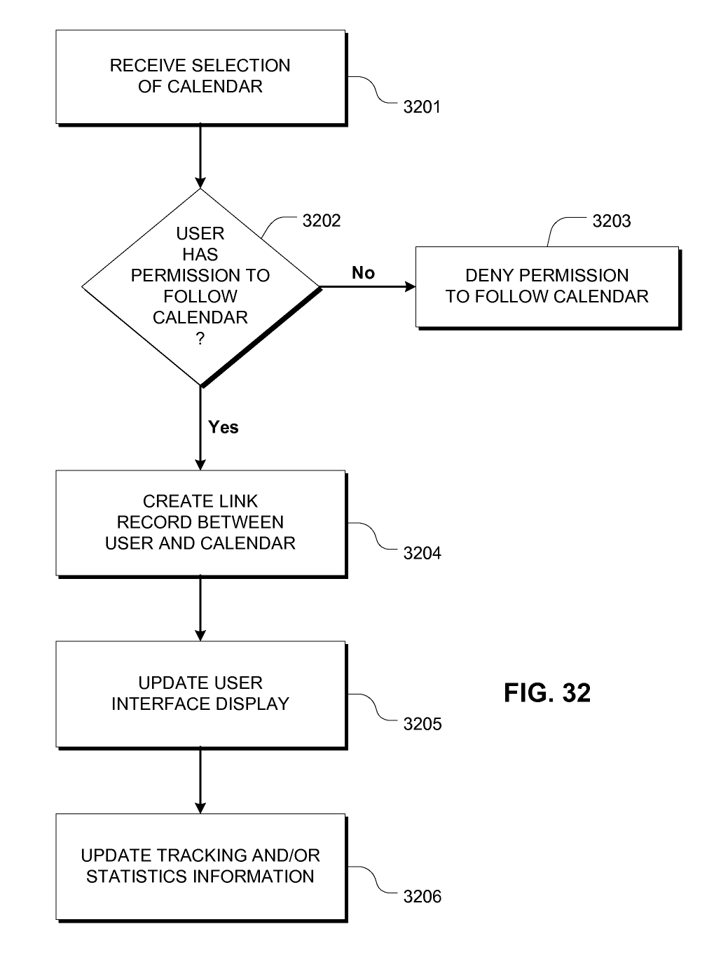

FIG. 32 is a flowchart of a process of following a calendar. A user may follow, for example, a public calendar, to indicate interest in the calendar and events listed on that calendar. For example, a restaurant might offer a public calendar of upcoming events at the restaurant, and users who wish to be informed about events for the restaurant may follow the calendar. Following a calendar is different from simply linking to multiple events on the calendar, because the user who follows a calendar may be able to view all events on that calendar—even events that are added after the user initially follows the calendar—whereas a user who only links to particular events on a calendar will not necessarily have additional events associated with the calendar displayed on their calendar display or account.

FIG. 32 is a flowchart of a process of following a calendar. Public calendars may be followed by any other user on the system, in an embodiment. In other embodiments, calendars may only be followed by particular users. The users who may follow a calendar may be determined by access control lists or by relationships with calendar members. In an embodiment, a calendar may only be followed by friends of the calendar's creator or by friends of other users following the calendar. Thus, calendar following may, in some embodiments, be based on a social network or relationship graph.

At step 3201 the system receives a selection of a calendar to be followed. The calendar may be selected by the user identifying the calendar through a search or by the user accessing a URL associated with the calendar, or by other means.

At step 3202 the system determines whether the user has permission to follow the selected calendar. The determination may be based on access control permissions associated with the calendar, such as whether the calendar is private or public. If the user lacks permission to follow the calendar, then at step 3203, permission to follow the calendar is denied and the user may be given a notification indicating the denial of permission.

If the user does have permission to follow the calendar, then at step 3204 a link is created between the user and the calendar. The link may be configured to indicate that the user is a follower of the selected calendar. The link may be maintained as a data structure, such as a calendar user link 507 shown in FIG. 5. Additionally, at step 3204 additional preferences associated with the newly created link, such as preferences 508 of FIG. 5, may be created and associated with the newly created link.

At step 3205 the calendar user interface display is updated to reflect the newly followed calendar. For example, the calendar listing 202 in FIG. 2 may be augmented to include the newly followed calendar. In an embodiment, the system receives a selection of parameters for the calendar, such as a group for the calendar and/or a color for the calendar, as well as other optional parameters. Those preferences are stored, for example, in the preferences associated with the calendar user link, and those preferences may be used in updating the user interface display at step 3205. In an embodiment, the system applies default preferences to the newly followed calendar, such as placing the calendar in a default group, such as a public group, and using a default color associated with the calendar for the color to be displayed on the user interface. This has the advantage of not requiring the user to provide substantial information at the time of following a calendar, and may enable the calendar to be followed using a single click rather than requiring the user to input information.

At step 3206 the system updates tracking and statistics information associated with the newly followed calendar. This tracking and statistics information may include information such as how many users are following a calendar and demographic or profile information about users who are following the calendar. Such tracking and statistics information may be useful to the creator of the calendar being followed, or other users. For example, if a restaurant creates a calendar and users follow the calendar, then the restaurant may use statistical information about the followers to target its potential new clientele. Such statistics provide opportunities for two-way communications between the calendar's creator or administrators and the calendar's followers. Additionally, in an embodiment, followers of a calendar are able to transmit individual messages or other information to creators or administrators of the calendar, and vice versa, to further enable two-way communications.

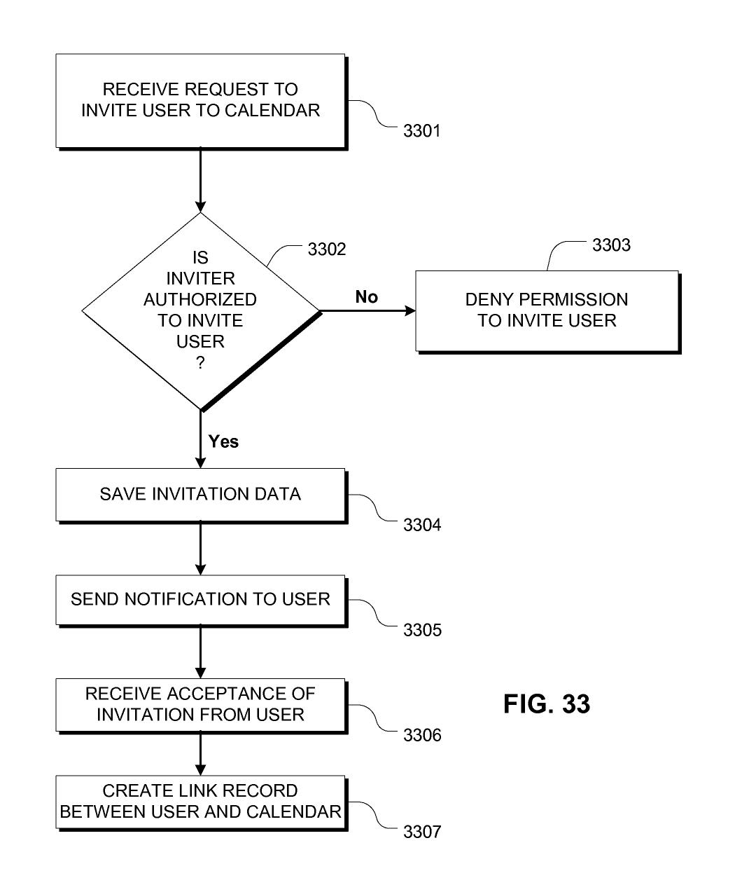

FIG. 33 is a flowchart of a process of adding users or members to a calendar. In an embodiment of the system, calendars may have followers and members which are different sets of users. A follower of a calendar would generally be associated with a public calendar and would generally only have “read” access to the calendar, although in various embodiments, followers of a calendar may have different levels of access, such as “write” access. A follower of a calendar generally also may choose to follow the calendar without any explicit invitation or permission from a calendar creator or administrator. In contrast, in this embodiment, a member of a calendar must be invited to access the calendar by an administrator or other appropriate user of the calendar. Additionally, private calendars may have members, although in an embodiment, private calendars may not have followers, as the calendar is not publicly accessible or viewable.

Thus, in an embodiment, a calendar may have both members and followers. The administrators of the calendar may specify access permissions for members and for followers separately.

At step 3301 the system receives a request to invite a user to the calendar. The request is received from a user who is referred to as the “inviter.” That user generally must be an administrator of the calendar or otherwise have permission to invite other users. The request to invite a user may be performed through a user interface such as that displayed on window 1401 of FIG. 14 or through other means. In step 3302 the system determines whether the inviter is authorized to invite the particular user. The determination may be based on attributes associated with the calendar, attributes associated with the user, and other factors. For example, if the inviter is an administrator of the calendar, then the inviter may have permission to invite the user. Additionally, the calendar may be configured to only accept certain users as permitted members of the calendar. For example, the calendar may be configured to only allow users with certain profile attributes, such as users in a certain location, to be members, or to only allow users who have certain relationships with other calendar members to be invited to the calendar. Thus, membership to calendars may be based on social networks or relationships. If the inviter does not have permission to invite the selected user to the calendar, then at step 3303 the system denies permission to invite the user and the system may notify the inviter of the denial of permission.

If the inviter is authorized to invite the user to the calendar, then at step 3304 invitation data is saved within the system. The invitation data may include information such as the user to be invited, information about the inviter, information about the calendar to which the user has been invited, and other information provided by the inviter, such as an invitation message.

At step 3305 a notification is sent to the user being invited to the calendar. The notification may be sent by any means enabled within the computing system, and the means of notification may be specified by the inviting user. The notification may contain information such as the particular calendar to which the user is being invited, profile information about the inviter, and other information provided by the inviter such as a personalized message. The notification may also include information about the calendar such as other members of the calendar and descriptive information to allow the invited user to decide whether or not to become a member of the calendar.

At step 3306 the system receives an acceptance of the invitation from the user. The invited user may accept the invitation by a number of means, such as by accessing a URL provided in the notification sent to the user at step 3305 or by accessing an invitation acceptance user interface provided by the calendar system within the invited user's account. In an embodiment, if the invited user does not have an account on the calendar system, the invited user is prompted to create an account prior to accepting the invitation.

In an embodiment, the inviter does not send out an invitation to the user, but instead adds the user as a member immediately to the calendar, in which case, steps 3304-3306 may not be performed.

At step 3307 the system creates a link record between the user and the calendar. The link record created at step 3307 may be a link record such as record 507 shown in FIG. 5 and as described previously, and the record may include calendar-user preferences such as those shown in element 508 of FIG. 5. The link created at step 3307 may include access permissions as provided by the inviter at the time of inviting the user to the calendar. The link record may also include an indication that the user is a member of a calendar, to distinguish the invited user from followers of the calendar. The link record may also contain other information as used by the system in associating the user and the calendar.

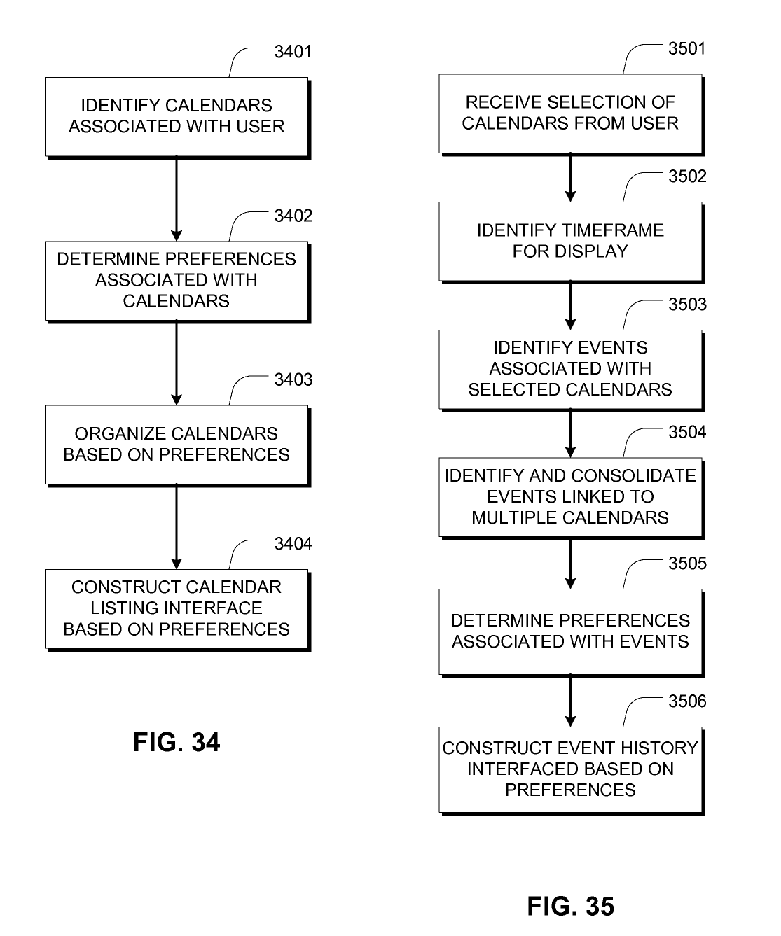

FIG. 34 is a flowchart of a process of constructing a calendar display interface, and in particular, the listing of calendars on the calendar display interface. For example, the process shown in FIG. 4 may be used to construct listing of calendars 202 shown in FIG. 2. The process shown in FIG. 34 may be performed when the user initiates a request to display the calendar display interface, or may be performed if the listing of calendars needs to be updated—for example, if the user adds a new calendar to the user's account or if the user updates any of the calendars on the user's accounts.

At step 3401 the system identifies the calendars associated with the user. The calendars associated with the user may include calendars that the user has created, calendars that the user is a member of, calendars that the user is following, or any other calendars that are associated with the user. The system may make this determination based on calendar user links associated with the user such as links 507 shown in FIG. 5.

At step 3402 the system determines preferences associated with the calendars identified in step 3401. The preferences may be stored in the data store in association with links, for example through the calendar-user preferences 508 in FIG. 5. Additional preferences for the identified calendars may be drawn from the preferences of the calendars themselves, such as preferences data 509 of FIG. 5. The preferences may include color information associated with the calendars, group information, information about which calendars are to be selected, such as in checkboxes 204 of FIG. 2, and other information.

At step 3403 the system organizes the identified calendars based on the preferences determined in step 3402. For example, if the user has associated calendars with particular groups, then the system may organize the identified calendars based on those groups. Additionally, the system may organize the calendars based on an ordering selected by the user, such as preference ordering, alphabetical ordering, ordering based on most recent updates, or other ordering schemes, as may be specified by the user or by an administrator of the system. Further organization of the calendars may be based on other information provided by the users, such as the favorite calendars selected by the user.

At step 3404 the system constructs a calendar listing interface based on the preferences. The constructed calendar listing may account for the organization of the calendars determined at step 3403. Additionally, the calendar listing interface may account for preferences such as color preferences provided by the user or provided as preferences to the identified calendars. The resulting constructed calendar listing interface may appear as listing 202 of calendars in FIG. 2. The resulting listing data may then be transmitted over to the user, either individually or as part of a larger calendar interface. In an embodiment, when the user updates a portion of the calendar listing, the calendar listing interface constructed at step 3404 is sent individually through an asynchronous web or internet response so that the calendar display interface may be updated without requiring a refresh of the entire web page.

FIG. 34 is a process of constructing the calendar event display such as that shown at element 208 of FIG. 2. This process may be performed subsequent to the process shown in FIG. 34 or it may be performed independently, for example, as a result of an update to particular events shown on the calendar interface.

At step 3501 the system receives a selection of calendars from the user. The selection of calendars may be all of the calendars associated with the user or it may be only a subset of those calendars. In an embodiment, the selection of calendars is based on the user's selection of calendars by using checkboxes 204 of FIG. 2 or using buttons 205 of FIG. 2, as previously described with reference to that figure.

At step 3502 the system identifies a timeframe to be displayed in the event display interface. The timeframe may be a particular month, week or day, as selected by the user.

At step 3503 the system identifies events associated with the selected calendars. In an embodiment, the identified events are those that fall within the identified timeframe for display, as determined at step 3502. The identification of events associated with the selected calendars may be based on the links between events and calendars, such as link 504 shown in FIG. 5.

At step 3504 the system identifies and consolidates events linked to multiple calendars. As explained previously, an event may be linked to multiple calendars and even multiple calendars of the same user. Thus, in order to improve the usability of the event display for users, the system consolidates those events which are included on multiple calendars so as to prevent them from appearing multiple times on the user's calendar display. The consolidation of multiple events may be done based on the links between calendars and events, such as link 504 of FIG. 5. In an embodiment, the system identifies all of the calendars associated with a particular event and determines preferences based on a combination of all of those calendars, or based on one of those calendars selected by certain user-provided preferences or other information available to the system.

At step 3505 the system determines preferences associated with the identified events. Those preferences may include coloring preferences associated with the particular events or the calendars to which the events are linked. The preferences may also indicate parameters for how the events are to display, such as what information is to be included on the event display. The preferences may be derived from calendar-event preferences associated with the link between an event and a calendar, such as preferences 505 of FIG. 5. The preferences associated with events may also be determined from the event preferences associated with particular events 503 and the calendar preferences 509 associated with the calendars through which the event is linked.

At step 3506 the system constructs an event display interface based on the preferences determines at step 3505 and other information as determined throughout this process. The event history in an embodiment is constructed to graphically represent the events on a calendar in a user-friendly manner, such as the event display 208 of FIG. 2. In an embodiment, the system organizes the events based on the date and time of those events and arranges the events on the display to reflect the duration of the events. In an embodiment, certain events may be marked as “all-day” events, and those events may be displayed to indicate that they encompass the entire day. Certain events may also span multiple days, and the interface would be configured accordingly to show the entire duration of the event.

In an embodiment where events overlap in time or in date, the interface may be configured to display those events in an overlapping graphical manner to enable the user to quickly determine when events overlap or conflict. In an embodiment, the system may determine that the number of events to be fit into a particular space on the display are too numerous to be adequately presented on the display. In such a situation, the system may adjust the display to appropriately compensate for this situation. For example, the system may, instead of displaying all the events individually, display an aggregate notice that there are a certain number of events collapsed into a single region on the event display. Alternately, the system may display a user interface element such as a “more” button, which will display events that cannot be shown in a particular region of the event display.

At step 3506 the system also graphically presents the events being displayed based on the preferences, such as color preferences provided by the user. The system also may configure the events with executable code to respond to interactions performed by the user with either the calendar listing constructed through the process shown in FIG. 34 or interactions with the displayed events through the event display constructed through the process of FIG. 35. Such interactions may include hovering over events, clicking on events, or providing keyboard or mouse input to the user interface. The executable code may cause events to change color or appearance and/or to display additional or alternate information relating to individual events. The executable code may also cause changes or modifications to events with which the user interacts. For example, if the user drags an event to a different location on the event display, that may cause a change in time or date associated with the affected event.

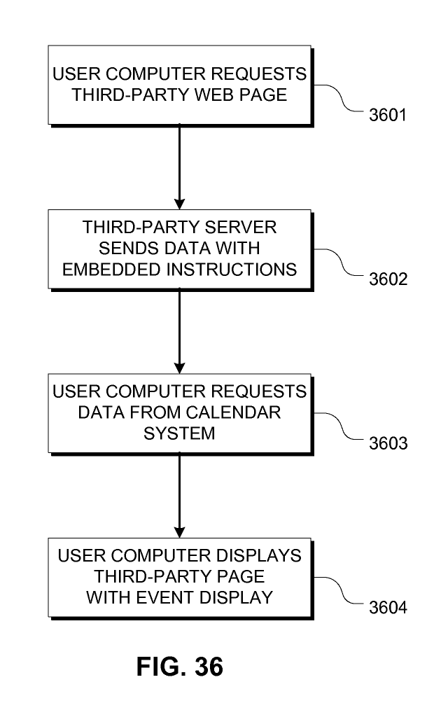

FIG. 36 shows a flowchart of an embodiment of a process of constructing a third-party web page with calendar information. This is useful for third-party websites who wish to easily display calendar information on the third party's own website. For example, if a restaurant creates a calendar of upcoming events occurring at that restaurant, the restaurant may wish to be able to easily display a listing of some events, or possibly even an entire calendar of those events, on the restaurant's own webpage. By drawing information directly from the calendar system onto the restaurant's own webpage, the restaurant no longer has to update calendar information on the third-party websites, thus ensuring that viewers of the websites have up-to-date information about events at the restaurant. Furthermore, by drawing information directly from the calendar system, visitors to the third-party website are able to easily import information about events on the third-party website into those visitors' calendars on the calendar system, thus facilitating ease of information transfer and flow.

At step 3601a user computer requests a third-party webpage. At step 3602 the third-party server responds to the request of step 3601 and sends webpage data with embedded instructions. The embedded instructions may be provided by the calendar system and included on webpage data at the third-party server. In an embodiment, the embedded instructions are JavaScript or other instructions that may be modified to indicate a particular event on a calendar associated with the third-party webpage. In an embodiment, the embedded instructions comprise an IFRAME tag with a URL to request information from the calendar system. In other embodiments, the user may request information other than a webpage, such as streaming media data or other data available online, and embedded instructions will be included in that data as appropriate for the requested data formats.

At step 3603 the user computer requests data from the calendar system based on the instructions at step 3602. The data may be complete webpage data or it may be data specifically formatted and relating to information about a particular event or calendar.

At step 3604 the user computer uses the data received at step 3603 as well as the data received at step 3602 to display the third-party webpage with an event or calendar display. The event or calendar display may be constructed based on instructions provided at step 3602 or further instructions provided at step 3603. In an embodiment, the event or calendar display is configured by the third-party webpage to be compatible with the look and feel of the third-party webpage. The event or calendar display may include executable code that enables the user to link particular events or to follow calendars on the user's account.

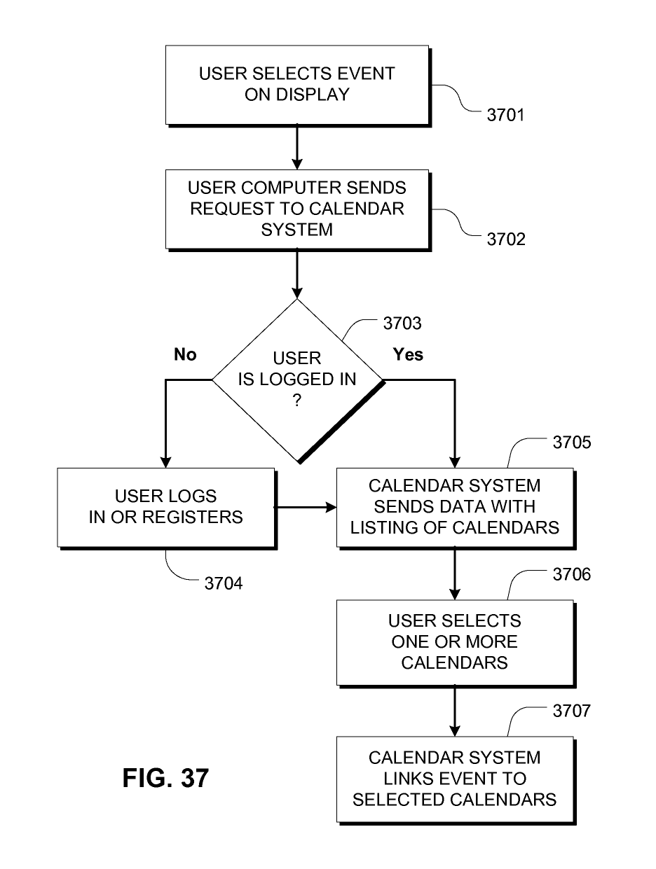

FIG. 37 is a flowchart of a process by which a user can link an event to one or more of the user's calendars through the third-party webpage displaying an event or calendar, such as through the process previously shown in FIG. 36.

At step 3701 the user selects an event on the event or calendar display presented on the third-party webpage. The user may select the events, for example, by clicking on an event, hovering a mouse cursor over that event, or the like.

At step 3702 the user computer sends a request to the calendar system based on the selection by the user of one or more particular events. The request may include information about the selected event and information about the user who is submitting the request. In an embodiment, the request sent to the calendar system includes a cookie or other information identifying the user who is sending the request to the calendar system, thus enabling the calendar system to associate the request with a particular user account.

At step 3703 the system determines whether the user who submitted the request at step 3702 is logged into an account on the calendar system. This determination may be based on the user information submitted at step 3702 or other information, such as an IP address associated with the request sent by the user computer. If at step 3703 it is determined that the user is not logged in, then the system requests that the user log in or register for an account with the calendar system at step 3704. In an embodiment, the request for the user to log in or register is presented as a pop-up window on the third-party webpage so as to not require the user to leave the third-party webpage. In another embodiment, the user is redirected to access a webpage on the calendar system to log in or register.

If the user is determined to be logged in at step 3703 or if the user logs in or registers at step 3704, then at step 3705 the calendar system sends data to the user computer. This data may include a list of calendars associated with the user's accounts. It may also include other information relating to the selected event, calendars associated with the selected event, or the like. The user computer may then use the data sent at step 3705 to create a user interface to enable the user to link the selected event to one or more calendars on that user's account. In an embodiment, this interface is presented as a pop-up window over the third-party webpage so as to not require the user to navigate away from the third-party webpage. In another embodiment, the user interface is presented as a separate webpage, either by redirecting the user to the separate webpage or by showing the separate webpage in a new tab or window on the user computer.

At step 3706 the user selects one or more calendars from the listing of calendars presented in the user interface created at step 3705. Based on the selection, the user computer then transmits data indicating the selected calendars to the calendar system.

At step 3707 the calendar system creates links between the selected events and the calendars selected at step 3706. Thus, the user has the selected event added to the selected calendars on the account. In an embodiment, the user is presented with a confirmation of the linking process performed at step 37 as a pop-up window over the third-party webpage so that the user never needs to leave the third-party webpage. In an embodiment, the pop-up window enables the user to specify further information or preferences to associate with the event, such as a name for the event or additional comments, colors or other information.

The display of calendar or event information may take on various forms. In an embodiment, one or more events are displayed in a list on the third-party page. In an embodiment, the list of events may be scrolled to view additional events. The list may include data such as the event name, date, time, and/or location, among other things. In an embodiment, only a link or icon is displayed, representing a single event. This may be useful, for example, on a web page or section of a page discussing only one event. In an embodiment, the display is laid out in the form of a calendar, which may either be displayed in full on the third-party page or displayed in response to a user interaction with the third-party page such as a click or mouse-over. In an embodiment, the display may be included in other environments, such as in an email, video, instant message, text message, or the like.

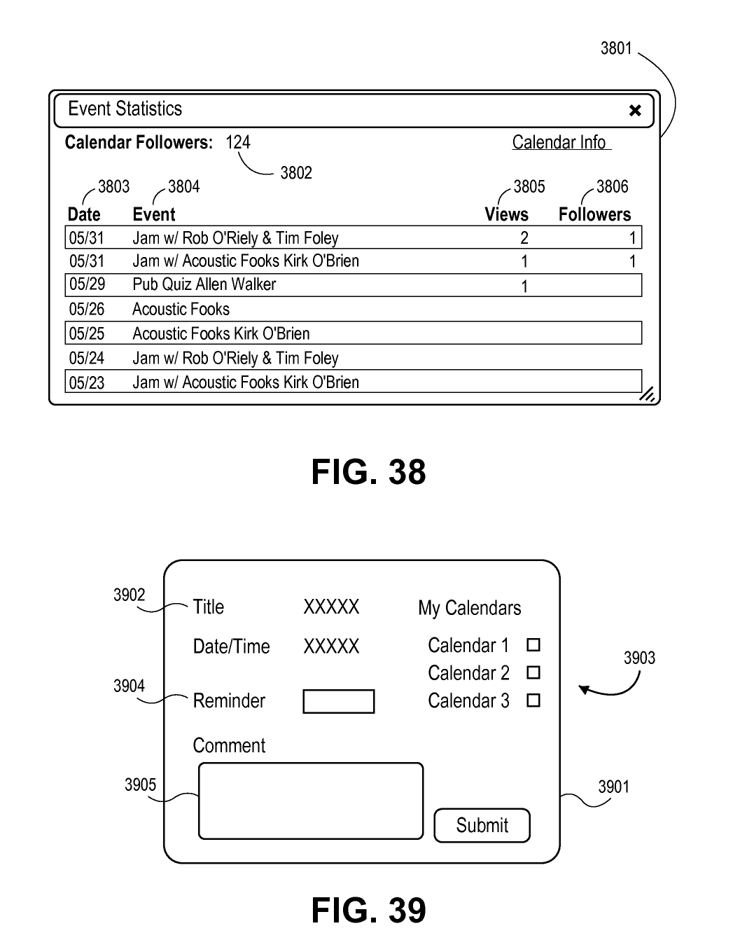

FIG. 38 shows a user interface displaying statistics about a calendar, as used in an embodiment. Window 3801 may be displayed based on selecting a link on a calendar, such as one in listing 1601 of FIG. 16, or from a calendar detail window, or by other means. In an embodiment, window 3801 is only presented for public calendars. In another embodiment, it is presented for all calendars.

The interface may, in various embodiments, display statistics relating to the calendar. In an embodiment, the number of follows 3802 is displayed. Additionally, the number of members or other users associated with the calendar may be displayed. Additionally, per-event statistics may be shown, for example in a tabular format showing information for events associated with the calendar, including the date 3803, the event title 3804, the number of times the event has been viewed 3805, and the number of followers of the event 3806 (e.g., the number of calendars to which the event is linked). These statistics may be tracked by the calendar system, along with other statistics. In an embodiment, elements 3805 and 3806 display numbers of unique users who have viewed the event or linked to the event. In alternate embodiments, the total number of views and/or links are displayed.

FIG. 39 shows an embodiment of a user interface for linking one or more events to a calendar. Window 3901 may be used in combination with methods such as those shown in FIGS. 36-37. In an embodiment, window 3901 is displayed in response to a user selecting an icon, link, or other user interface element on a third-party web page. In another embodiment, the contents of window 3901 are incorporated into the third-party web page. In various embodiments, window 3901 may be displayed as a pop-up within the same web page as the third-party web page (e.g., like window 301 of FIG. 3), as a separate window or tab, or by other means known to those of skill in the art.

Window 3901 may, in an embodiment, include information 3902 such as the title, date/time, and other information relating to an event. In an embodiment, the particular event has been specified by the third-party website. The window further provides a list of calendars 3903 associated with a user's account, so that the user may select calendars to which the event will be linked. Additionally, the user may specify a reminder 3904 and additional comments or information 3905 to be associated with the event. Upon submitting the information in window 3901, the system may proceed to link the selected event to the calendars selected by the user, and update information relating to the event.

### Example System Architecture

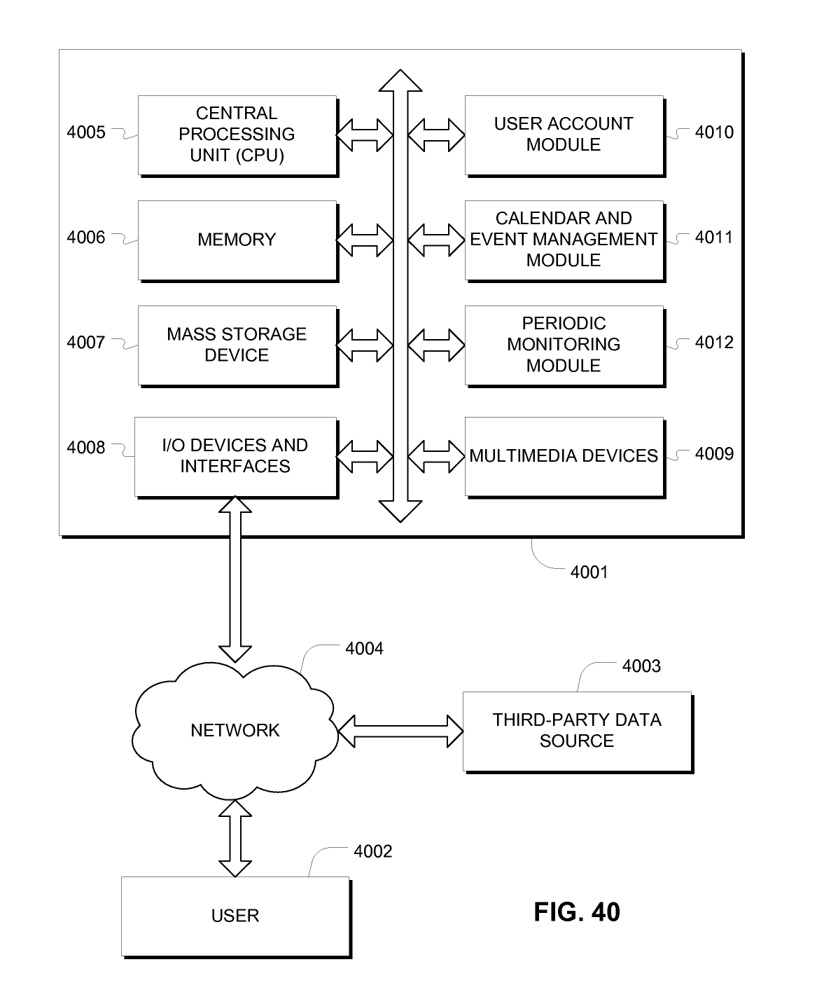

FIG. 40 is a block diagram illustrating one embodiment of a system that manages calendar data. In the embodiment of FIG. 40, a computing device 4001 is in communication with a user 4002, as well as an optional third-party data source 4003, via a network 4004. In an embodiment, the computing device 4001 receives data, such as calendar or event data, from one or more data sources 4003 and accesses the data to identify information regarding one or more entities. The computing device 4001 may then perform analysis and prepare information for presentation to the user 4002. The calendar computing system 101 may include the same or similar components as the computing device 4001. Similarly, the computing devices 4001 may be used to implement any of the methods discussed herein.

The network 4004 may include any communication network or combination of communication networks, such as one or more of the Internet, LANs, WANs, MANs, etc., for example. In the embodiment of Figure 4001, the computing device 4001 includes a computing system having one or more computing devices (e.g., computers). The computing device 4001 may include, for example, a single computing device, a computer server, a smart storage unit, or a combination of one or more computing devices and/or computer servers. Depending on the embodiment, the components illustrated in the computing device 4001 may be distributed amongst multiple devices, such as via a local area or other network connection. In other embodiments the computing device 4001 may include fewer and/or additional components that are illustrated in FIG. 40.

The exemplary computing device 4001 may be a general purpose computer using one or more microprocessors, such as, for example, an Intel® Pentium® processor, an Intel® Pentium® II processor, an Intel® Pentium® Pro processor, an Intel® Pentium® IV processor, an Intel® Pentium® D processor, an Intel® Core™ processor, an xx86 processor, an 8051 processor, a MIPS processor, a Power PC processor, a SPARC processor, an Alpha processor, and so forth. The computer may run a variety of operating systems that perform standard operating system functions such as, for example, opening, reading, writing, and closing a file. It is recognized that other operating systems may be used, such as, for example, Microsoft® Windows® 3.X, Microsoft® Windows 98, Microsoft® Windows® 2000, Microsoft® Windows® NT, Microsoft® Windows® CE, Microsoft® Windows® ME, Microsoft® Windows® XP, Windows® 7, Palm Pilot OS, Apple® MacOS®, Disk Operating System (DOS), UNIX, IRIX, Solaris, SunOS, FreeBSD, Linux®, or IBM® OS/2® operating systems. In other embodiments, the computing device 4001 may be controlled by a proprietary operating system. Conventional operating systems control and schedule computer processes for execution, perform memory management, provide file system, networking, I/O services, and provide a user interface, such as a graphical user interface (“GUI”), among other things.

The computing device 4001 includes one or more central processing units (“CPU”) 4005, which may each include one or more conventional or proprietary microprocessor(s). The computing device 4001 may further include one or more memories 4006, such as random access memory (“RAM”), for temporary storage of information, read only memory (“ROM”) for permanent storage of information, and/or a mass storage device 4007, such as a hard drive, diskette, or optical media storage device. The memory 4006 may store software code, or instructions, for execution by the processor 4005 in order to cause the computing device to perform certain operations, such as gathering sensor-related data, processing the data with statistical and/or predictive models, formatting data for user devices or other presentation, transmitting data, or other operations described or used herein.

The methods described and claimed herein may be performed by any suitable computing device, such as the computing device 4001. The methods may be executed on such suitable computing devices in response to execution of software instructions or other executable code read from a non-transitory tangible computer readable medium or computer storage device. A computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

The exemplary computing device 4001 may include one or more input/output (I/O) devices and interfaces 4008, such as a keyboard, trackball, mouse, drawing tablet, joystick, game controller, touchscreen (e.g., capacitive or resistive touchscreen), touchpad, accelerometer, and/or printer, for example. The computing device 4001 may also include one or more multimedia devices 4009, such as a display device (also referred to herein as a display screen), which may also be one of the I/O devices 4008 in the case of a touchscreen, for example. Display devices may include LCD, OLED, or other thin screen display surfaces, a monitor, television, projector, or any other device that visually depicts user interfaces and data to viewers. The computing device 4001 may also include one or more multimedia devices, such as speakers, video cards, graphics accelerators, and microphones, for example.

In the embodiment of FIG. 40, the I/O devices and interfaces 4008 provides a communication interface to various external devices via the network 4004. For example, the computing device 4001 may be electronically coupled to the network 4004 via a wired, wireless, or combination of wired and wireless, communication link(s). The network 4004 may allow communication with various other computing devices and/or other electronic devices via wired or wireless communication links.

In the embodiment of FIG. 40, the computing device 4001 may include a user account module 4010, a calendar and event management module 4011, and a periodic monitoring module 4012, as well as other modules or fewer modules. Each of these modules is discussed in further detail below. In general, the word “module,” as used herein, refers to logic embodied in hardware or firmware, or to a collection of software instructions, possibly having entry and exit points, written in any programming language, such as, for example, Java, Python, Perl, Lua, C, C++, C#, Objective C, etc. A software module may be compiled and linked into an executable program, installed in a dynamic link library, or may be written in an interpreted programming language such as, for example, BASIC, Perl, or Python. Software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the computing device 4001, for execution by the computing device. Hardware modules may be comprised of connected logic units, such as gates and flip-flops, and/or may be comprised of programmable units, such as programmable gate arrays or processors. The modules described herein are typically implemented as software modules, but may be implemented in hardware, firmware and/or software. Generally, the modules described herein refer to logical modules that may be combined with other modules or divided into sub-modules despite their physical organization or storage.

### Example Modules

In the embodiment of FIG. 40, the computing device 4001 includes three modules, namely, a user account module 4010, a calendar and event management module 4011, and a periodic monitoring module 4012. In this embodiment, each of the modules is shown as part of the computing device 4001. However, in other embodiments, the modules may be distributed across multiple devices, and may be controlled and/or operated by multiple different entities. These modules are configured to perform methods as described throughout this specification. In various embodiments, fewer or additional modules may be included within a computing system.

The computing device 4001 may be configured to acquire user data and other external data such as third-party data. The acquisition module may comprise software alone, hardware alone, or a combination of software and hardware. The device may be especially adapted to communicate using a variety of network or communications protocols in order to communicate with the sensors or external data sources. Some of these protocols may include standard network protocols, such as HTTP, FTP, SNMP, or the like. The device may further include hardware drivers, such as USB, FireWire, Thunderbolt (Light Peak), or serial communications drivers, for example to communicate with devices in direct communication with the system.

The computing device 4001 may be configured to transmit, or initiate transmission of, data such as user interfaces or calendar or event information to requesting entities, such as external user 4002, that have registered interest with the system. In one embodiment, the device provides the data in an unformatted data structure, such as in an XML, CSV, TXT, or other spreadsheet, text, or web accessible data structure. In other embodiments, the device provides information in user interfaces, such as user interfaces that are configured for rendering by a web browser for display to users. A variety of different presentations may be provided. In some embodiments, the requesting entities may indicate presentation preferences or configurations (e.g., data formats, types of information, players of interest), and the device may transmit data based on the indicated preferences or configurations. The presentation format may also be determined based on the type of device being used by the user.

In an embodiment, any or all of the modules 4010-4012 are configured to act in real time. Thus, when data is received by the modules, the modules process that data as soon as practicable or necessary to provide users with timely information. In order to achieve this, specialized hardware may be used to gain efficiency, and executable code may be designed to minimize latency or computation time. In an embodiment, the modules, possibly with other modules of the system, are executed within a real-time operating system, to enhance the responsiveness of the system.

Several flowcharts and related methods are described throughout this specification. Although each flowchart illustrates a particular quantity of blocks, the methods associated with the flowcharts may include any subset of illustrated blocks, or may include additional blocks that are not illustrated. Also, the blocks may be performed in orders different than illustrated in the figures. Software code configured for execution on a computing system in order to perform the methods of respective flowcharts may be provided on a computer readable medium, such as a compact disc, digital video disc, flash drive, hard drive, memory device or any other tangible medium. Such software code may be stored, partially or fully, on a memory of a computing system, in order to perform the illustrated methods by those respective devices. For ease of explanation, the methods will be described herein as performed by a computing system, which should be interpreted to include any one or more of the computing systems noted above, any combination of those computing systems, and/or any other suitable computing system.

Although this disclosure has been described in terms of certain example embodiments and applications, other embodiments and applications that are apparent to those of ordinary skill in the art, including embodiments and applications that do not provide all of the benefits described herein, are also within the scope of this disclosure.

All publications and patent applications mentioned in this specification are herein incorporated by reference in their entirety to the same extent as if each individual publication or patent application was specifically and individually indicated to be incorporated by reference.

What is claimed is:

1. A method of integrating public and private calendars on a user-specific basis, whereby a user is able to view multiple shared calendars created by different users, the method being performed on computing hardware comprising a processor, the method comprising:
maintaining event data relating to a first future event;
receiving a request from a user to add the first future event to a first calendar of the user;
creating a link between the first future event and the first calendar, the link being configured so that updates to the first future event are reflected on the first calendar, the link further being configured to enable the user to modify one or more attributes associated with the first future event without affecting the event data; and
transmitting first user interface data configured to cause the display of a calendar interface comprising a representation of the first future event.

2. The method of claim 1, further comprising:
receiving a request from the user to add a second future event to a second calendar of the user;
determining that the second future event corresponds to the first future event; and
transmitting second user interface data configured to cause the display of a calendar interface comprising a consolidated representation of the first future event and the second future event, the consolidated representation being configured to graphically indicate an association with the calendar of the user in response to a first user input action, the consolidated representation further being configured to graphically indicate an association with the second calendar of the user in response to a second user input action different from the first user input action.

3. The method of claim 1, further comprising:
receiving a request to modify a date associated with the first future event;
modifying the event data in response to the request to modify the date;
transmitting a notification message to the user, the notification message identifying the first future event and comprising the modified date associated with the first future event; and
transmitting, to the user in response to a user request, second user interface data configured to cause the display of a calendar interface comprising a modified representation of the first future event reflecting the modified date associated with the first future event, whereby the user need not manually update the link or the first future event.

4. The method of claim 1, wherein the link between the first future event and the first calendar comprises access permission data indicating whether the user is authorized to modify the first future event, and wherein the method further comprises:
receiving a request from the user to modify the first future event;
determining, based on the access permission data, that the user is not authorized to modify the first future event; and
notifying the user that modification of the first future event is not permitted.

5. The method of claim 1, further comprising:
receiving search parameters from the user;
identifying one or more future events based on the received search parameters;
transmitting a search result user interface comprising a listing of the one or more future events, wherein the listing is configured to enable the user to select one or more calendars to link with a selected event of the one or more future events;
wherein the first future event is one of the one or more future events identified based on the received search parameters, the first calendar is one of the one or more calendars, and the request from the user to add the first future event to the first calendar is based on the search result user interface.

6. The method of claim 5, wherein the search parameters comprise an indication of a location, and wherein identifying one or more future events based on the received search parameters is based at least in part upon calculated distances between the location of the search parameters and locations associated with the one or more future events.

7. The method of claim 1, wherein the first future event is a publicly accessible event, and wherein the first calendar is a private calendar.

8. A computer-implemented system configured to manage calendars on a user-specific basis, the system comprising:
one or more computing processors;
computer-readable storage media in communication with the one or more computing processors; and
executable instructions stored on the computer-readable storage media, the executable instructions configured to cause the one or more computing processors to perform operations comprising:
receiving a request to add a first event to a first calendar;
creating a link between the first event and the first calendar, the link being configured so that updates to the first future event are reflected on the first calendar, the link further being configured to enable the user to modify one or more attributes associated with the first future event without affecting the event data; and
transmitting first user interface data configured to cause the display of a calendar interface comprising a representation of the first future event.

9. The system of claim 8, wherein the executable instructions are further configured to cause the one or more computing processors to perform further operations comprising:
receiving a request to add a second event to a second calendar;
determining that the second event corresponds to the first event; and
transmitting second user interface data configured to cause the display of a calendar interface comprising a consolidated representation of the first event and the second event.

10. The system of claim 8, wherein the executable instructions are further configured to cause the one or more computing processors to perform further operations comprising:
modifying a date associated with the first event in response to a user request; and
transmitting a notification message identifying the first event, the notification message comprising the modified date.

11. The system of claim 8, wherein the link between the first event and the first calendar comprises access permission data indicating whether the user is authorized to modify the first event.

12. The system of claim 8, wherein the first event is selected in response to transmitting a search result user interface comprising a listing of events matching user-provided search parameters.

13. The system of claim 8, wherein the first event is associated with an indication of a location, and wherein the executable instructions are further configured to cause the one or more computing processors to calculate a distance between the location associated with the first event and a user-provided location.

14. The system of claim 8, wherein the first event is a publicly accessible event, and wherein the first calendar is a private calendar.

15. A computer-readable medium comprising executable instructions that, when executed on computing hardware, cause the computing hardware to perform operations comprising:
receiving a request to add a first event to a first calendar;
creating a link between the first event and the first calendar, the link being configured so that updates to the first future event are reflected on the first calendar, the link further being configured to enable the user to modify one or more attributes associated with the first future event without affecting the event data; and
transmitting first user interface data configured to cause the display of a calendar interface comprising a representation of the first future event.

16. The computer-readable medium of claim 15, in combination with one or more computer processors.
